(19) United States
(12) Patent Application Publication
(10) Pub. No.: US 2009/0304237 A1
(43) Pub. Date: Dec. 10, 2009

(54) Biometric Authentication Apparatus

(75) Inventors: Seiji Yoshikawa, Tokyo (JP); Masayuki Satou, Tokyo (JP); Masakazu Takei, Tokyo (JP); Toshiya Nagao, Tokyo (JP)

Correspondence Address: HOGAN & HARTSON L.L.P., 1999 AVENUE OF THE STARS, SUITE 1400, LOS ANGELES, CA, 90067, US

(73) Assignees: KYOCERA CORPORATION, Kyoto-shi, Kyoto (JP); KYOCERA OPTEC CORPORATION, Ome-shi, Tokyo (JP)

(21) Appl. No.: 11/994,238

(22) PCT Filed: Jun. 28, 2006
(86) PCT No.: PCT/JP2006/312899

§ 371 Date: Jul. 2, 2009

(30) Foreign Application Priority Data
Jun. 29, 2005 (JP) 2005-190436
Oct. 28, 2005 (JP) 2005-313758
Oct. 28, 2005 (JP) 2005-313759
Dec. 27, 2005 (JP) 2005-376660
Dec. 27, 2005 (JP) 2005-376661

(51) Int. Cl. G06K 9/00

(52) U.S. Cl. 382/116; 382/115; 382/117; 382/124

(57) ABSTRACT

A biometric authentication apparatus having a simple configuration, able to easily focus on a fingerprint or a vein or other blood vessel pattern and able to clearly capture an image of the same, able to prevent forgery, and in addition able to realize high precision authentication, which biometric authentication apparatus 100 having a transparent plate 110 formed by for example glass or plastic for placement of the finger of the authenticated person, that is, the inspected specimen OBJ, downward in the figure (surface where fingerprint is located facing downward), a fingerprint capturing use illumination apparatus 120, a vein capturing use illumination apparatus 130, and an image capturing apparatus 140, which image capturing apparatus 140 has an imaging lens apparatus capturing a dispersed image of an object passing through the optical system and phase plate, an image processing apparatus generating a dispersion-free image signal from a dispersed image signal from the imaging element, and an object approximate distance information detection apparatus generating information corresponding to the distance to the object, and which the image processing apparatus generating a dispersion-free image signal from the dispersed image signal based on the information generated by the object approximate distance information detection apparatus.

### TECHNICAL FIELD

The present invention relates to a biometric authentication apparatus, more particularly relates to a biometric authentication apparatus enabling fingerprint authentication, vein authentication, and further iris authentication etc.

### BACKGROUND ART

In the past, as the method for authenticating a person, the method of using a physical key or password is known, but recently the security of these has become viewed as a problem due to lock picking and card skimming. For this reason, in recent years, the method of identifying a person by biometric authentication has been increasingly employed.

The reasons for the increase of biometric authentication are that fingerprints and veins are considered not to change throughout one's life so are suitable for authenticating a person and, further, unlike a key or password, are free from worry over being lost, stolen, or forgotten.

As the method of authentication using a fingerprint, many methods are proposed such as for example the method disclosed in Patent Document 1.

As the methods of coping with copying and replication of fingerprints, a method of judging if a specimen is biological when authenticating a fingerprint is disclosed in Patent Document 2 etc.

Further, as an apparatus employing a method of authentication using vein or other blood vessel patterns, for example, a personal authentication apparatus having a handle shaped data acquisition unit having a curvature be gripped so as to enable image data of a plurality of fingers to be obtained with a good reproducibility or a personal authentication apparatus provided with a case for inserting a finger, a light source, an interference filter unit, an image capturing unit for capturing transmission light passing through the interference filter unit, and an imaging data use image processing apparatus has been proposed.

Further, a personal authentication apparatus for authentication by using two or three or more sets of information of the fingerprint and vein patterns; an image forming apparatus provided with a vein pattern and fingerprint recognition unit, an operator recognition unit, etc. and able to request the vein pattern and fingerprint as an ID; a personal identification system collating a fingerprint and also collating a blood vessel pattern of the fingertip to improve the accuracy of the personal confirmation; a personal identification apparatus realizing quick and precise personal identification with a smaller amount of data, etc. have been proposed.

For the authentication and identification in apparatuses of these types, use is made of digital image data of digital cameras and other image capturing apparatuses.

In recent years, rapid advances have been made in digitalization of information. This has led to remarkable efforts to meet with this in the imaging field.

In particular, as symbolized by the digital camera, as the imaging surfaces, the conventional film is being taken over by use of solid-state imaging elements such as CCDs (Charge Coupled Devices) or CMOS (Complementary Metal Oxide Semiconductor) sensors in most cases.

An imaging lens apparatus using a CCD or CMOS sensor for the imaging element in this way optically captures the image of an object by the optical system and extracts the image as an electric signal by the imaging element. Other than a digital still camera, this is used in a video camera, a digital video unit, a personal computer, a mobile phone, a personal digital assistant (PDA), and so on.

FIG. 1 is a diagram schematically showing the configuration of a general imaging lens apparatus and a state of light beams.

This imaging lens apparatus 1 has an optical system 2 and a CCD or CMOS sensor or other imaging element 3.

The optical system includes object side lenses 21 and 22, a stop 23, and an image formation lens 24 sequentially arranged from the object side (OBJS) toward the imaging element 3 side.

In the imaging lens apparatus 1, as shown in FIG. 1, the best focus surface is made to match with the imaging element surface.

FIG. 2A to FIG. 2C show spot images on a light receiving surface of the imaging element 3 of the imaging lens apparatus 1.

Further, image capturing apparatuses using phase plates (wavefront coding optical elements) to regularly disperse the light beams, using digital processing to restore the image, and thereby enabling capture of an image having a deep depth of field and so on have been proposed (see for example Non-patent Documents 1 and 2 and Patent Documents 3 to 7).

Patent Document 1: Japanese Patent Publication (A) No. 54-85600

Patent Document 2: Japanese Patent Publication (A) No. 7-308308

Non-patent Document 1: “Wavefront Coding; jointly optimized optical and digital imaging systems”, Edward R. Dowski, Jr., Robert H. Cormack, Scott D. Sarama.

Non-patent Document 2: “Wavefront Coding; A modern method of achieving high performance and/or low cost imaging systems”, Edward R. Dowski, Jr., Gregory E. Johnson.

Patent Document 3: U.S. Pat. No. 6,021,005

Patent Document 4: U.S. Pat. No. 6,642,504

Patent Document 5: U.S. Pat. No. 6,525,302

Patent Document 6: U.S. Pat. No. 6,069,738

Patent Document 7: Japanese Patent Publication (A) No. 2003-235794

### DISCLOSURE OF THE INVENTION

### Problems to be Solved by the Invention

In the fingerprint authentication disclosed in Patent Document 1, there is the disadvantage that use of a copy of a fingerprint or a replica of a finger formed with the copied fingerprint enables a third party to be easily authenticated. Further, there is the disadvantage that when the fingerprint is dirty or damaged, authentication is hard.

Further, in a case of use of vein or other blood vessel patterns for authentication, unlike fingerprints, forgery is difficult, but there is the disadvantage that the authentication is not possible when the specimen changes in temperature, is greatly injured, etc.

As an example dealing with this, as explained above, an authentication method using two or more sets of information of the fingerprint and vein pattern has been proposed. However, a fingerprint and vein or other blood vessel pattern is not present on the same plane, therefore when using a single imaging system, movement of the focal point becomes necessary, but no details of this have been proposed. Accordingly, in the conventional apparatuses, one of the images will become unfocused, so it is difficult to realize authentication with a high precision.

Further, it is possible to focus by moving the focal point. However, this results in a larger size and higher cost of the apparatus and further becomes a problem from the viewpoint of durability as well.

Further, all of the image capturing apparatuses proposed in the documents explained above are predicated on a PSF (Point-Spread-Function) being constant when inserting the above phase plate in the usual optical system. If the PSF changes, it is extremely difficult to realize an image having a deep depth of field by convolution using the subsequent kernels.

Accordingly, even in the case of lenses with a single focal point, in the usual optical system changing in its spot image according to the object distance, a constant (not changing) PSF cannot be realized. In order to solve this, a high level of precision of the optical design of the lenses is required. The accompanying increase in costs causes a major problem in adoption of this.

Further, in recent years, leakage of important secret information has frequently occurred and the importance of management of the data has risen. Therefore, it has been considered to raise the authentication precision by performing a plurality of authentication operations. However, when installing an apparatus for each authentication operation, there arises a problem in view of costs, installation location, and maintenance.

Further, as another problem, since the fingerprint and vein or other blood vessel pattern are not present on the same plane, where using a single imaging system, movement of the focal point becomes necessary. In the authentication apparatuses proposed at present, one of the images becomes unfocused.

It is possible to focus by moving the focal point, but this would cause a larger size and increased cost of the system and further problems in the durability.

Further, there are many persons who dislike directly touching something since they do not know who touched it before. Therefore, it has been demanded to perform the authentication without involving touching the authentication apparatus. However, the location of the object can no longer be fixed to a specific location, so the problem of the focal point arises in the same way as explained before. Further, the size of a captured object differs according to the distance, therefore this may also influence the authentication precision.

Further, even if “not changing throughout one's life”, the authentication object will change in size. For example, the size will differ due to aging and, when scanning the hand, due to the position of the same.

Regarding to change due to aging, there may be almost no further change starting from a certain age. However, there will be change in the growth period such as with children. Further, in an apparatus using a format where the hand is placed over a scanner, the capturing result will differ even with the same person according to the position where the hand is scanned.

In such a case, image processing may be used, but the image data obtained from a small hand or a hand scanned at a distant location will end up differing in resolution.

Further, although the probability of the existence of the same patterns is low, it would be difficult to eliminate erroneous authentication of a person while reliably eliminating intentionally forged patterns. Therefore, it may be considered to reduce the probability of erroneous authentication by performing a plurality of authentication operations, for example, for a combination of a fingerprint and finger veins and combination of a fingerprint and/or palm print and iris. However, this is accompanied by a larger size and increased cost of the apparatus. Therefore, erroneous authentication is reduced while avoiding the larger size of the apparatus and the increase of the cost and, at the same time, authentication in accordance with the security level is enabled.

A first object of the present invention is to provide a biometric authentication apparatus having a simple configuration, able to easily focus on a fingerprint or a vein or other blood vessel pattern and able to clearly capture an image of the same, able to prevent forgery, and in addition able to realize high precision authentication.

A second object of the present invention is to provide a biometric authentication apparatus having a simple configuration, able to easily focus on a plurality of biometric information units, able to clearly capture an image, able to perform a plurality of authentication operations such as iris authentication, fingerprint authentication, and vein authentication by a single apparatus, and in addition able to realize high precision authentication and able to reduce an erroneous authentication rate.

A third object of the present invention is to provide a biometric authentication apparatus having a simple configuration, able to flexibly cope with a change of size of an authenticated part of a biometric, able to easily focus on a fingerprint or vein or other blood vessel pattern and able to clearly capture an image, able to prevent forgery, and in addition able to realize high precision authentication.

### Means for Solving the Problems

To attain the above objects, a biometric authentication apparatus according to a first aspect of the present invention has an image capturing apparatus for capturing an authenticated object, wherein the image capturing apparatus includes an optical system and an optical wavefront modulation element, an imaging element for capturing a dispersed image of an object passing through the optical system and the optical wavefront modulation element, and a converting means for generating a dispersion-free image signal from a dispersed image signal from the imaging element.

Preferably, it has an information introduction unit able to introduce a plurality of authentication use information light of a different plurality of portions guided through predetermined light paths into the imaging element, and the biometric authentication apparatus performs authentication operations on the different plurality of portions.

Preferably, the optical wavefront modulation element is formed in the information introduction unit.

Preferably, the optical system includes a zoom optical system, and the image capturing apparatus able to adjust a size of an object input to the imaging element to a constant size by the zoom optical system.

Preferably, the optical system includes a zoom optical system, the biometric authentication apparatus further has an image processing means for applying predetermined image processing to the image captured by the imaging element, and at the time of the authentication, compares the image data of the object captured by the imaging element generated by the image processing means with a reference authentication data set in advance and drives the zoom optical system so as to adjust the size of an object image fetched by the imaging element, and the reference authentication data is data obtained by the imaging element capturing the object in a state where the zoom optical system is fixed at a predetermined location and generated by the image processing means.

Preferably, the biometric authentication apparatus further has an image processing means for applying predetermined image processing to the image captured by the imaging element and, at the time of the authentication, selects a number or combination of authentication portions and compares the image data of the selected authentication portions of the object captured by the imaging element with the reference authentication data to perform the authentication, and the reference authentication data is the data obtained by the imaging element capturing the object and generated for a plurality of positions by the image processing means.

Preferably, the image capturing apparatus is controlled so as to read two different predetermined patterns to perform the biometric authentication.

Preferably, the zoom optical system is set in the operating state when the authenticated object changes.

Preferably, the authenticated object includes a fingerprint and blood vessel.

Further, the different plurality of portions includes a fingerprint and blood vessel or a blood vessel and iris.

Preferably, a priority order of authentication results able to be switched in accordance with the situation.

Preferably, the image capturing apparatus is provided with an object distance information generating means for generating information corresponding to a distance up to an object, and the converting means generates a dispersion-free image signal from the dispersed image signal based on the information generated by the object distance information generating means.

Preferably, the image capturing apparatus is provided with a conversion coefficient storing means for storing in advance two or more conversion coefficients corresponding to the dispersion caused by at least the optical wavefront modulation element in accordance with the object distance and a coefficient selecting means for selecting a conversion coefficient in accordance with the distance up to the object from the conversion coefficient storing means based on the information generated by the object distance information generating means, and the converting means converts the image signal according to the conversion coefficient selected at the coefficient selecting means.

Preferably, the image capturing apparatus is provided with a conversion coefficient operation means for computing a conversion coefficient based on the information generated by the object distance information generating means, and the converting means converts the image signal according to the conversion coefficient obtained from the conversion coefficient operation means.

Preferably, the optical system including a zoom optical system, and the image capturing apparatus is provided with a correction value storing means for storing in advance at least one correction value in accordance with a zoom position or zoom amount of the zoom optical system, a second conversion coefficient storing means for storing in advance conversion coefficients corresponding to the dispersion caused by at least the optical wavefront modulation element, and a correction value selecting means for selecting a correction value in accordance with the distance up to the object from the correction value storing means based on the information generated by the object distance information generating means, and the converting means converts the image signal according to the conversion coefficient obtained from the second conversion coefficient storing means and the correction value selected by the correction value selecting means.

Preferably, the correction value stored in the correction value storing means includes a kernel size of the dispersed image of the object.

Preferably, the image capturing apparatus is provided with an object distance information generating means for generating information corresponding to a distance up to an object and a conversion coefficient operation means for computing a conversion coefficient based on the information generated by the object distance information generating means, and the converting means converts the image signal according to the conversion coefficient obtained from the conversion coefficient operation means and generates a dispersion-free image signal.

Preferably, the conversion coefficient processing means includes a kernel size of the dispersed image of the object as a variable.

Preferably, the apparatus has a storing means, the conversion coefficient operation means stores a found conversion coefficient in the storing means, and the converting means converts the image signal according to the conversion coefficient stored in the storing means and generates a dispersion-free image signal.

Preferably, the converting means performs a convolution operation based on the conversion coefficient.

A second aspect of the present invention is a biometric authentication apparatus provided with an image capturing apparatus for reading predetermined patterns of predetermined positions, wherein the image capturing apparatus has a zoom optical system, an imaging element for capturing an image passing through the zoom optical system, and an image processing means for applying a predetermined image processing with respect to the image captured by the imaging element and, at the time of the authentication, compares the image data of the object captured by the imaging element generated by the image processing means with reference authentication data set in advance and drives the zoom optical system so as to adjust the size of an object image fetched by the imaging element, and the reference authentication data is data obtained by the imaging element capturing the object in a state where the zoom optical system is fixed at the predetermined location and generated by the image processing means.

A third aspect of the present invention is a biometric authentication apparatus provided with an image capturing apparatus for reading predetermined patterns of predetermined positions, wherein the image capturing apparatus has an optical system, an imaging element for capturing an image passing through the optical system, and an image processing means for applying predetermined image processing to the image captured by the imaging element and, at the time of the authentication, selects a number or combination of authentication portions and compares the image data of the selected authentication portions of the object captured by the imaging element with reference authentication data to perform the authentication, and the reference authentication data is data generated for a plurality of portions by the image processing means by the imaging element capturing the object.

### EFFECTS OF THE INVENTION

According to the present invention, with a simple configuration, it is possible to easily focus on a fingerprint or vein or other blood vessel patterns and capture a clear image, possible to prevent forgery, and in addition possible to realize high precision authentication.

According to the present invention, with a simple configuration, it is possible to easily focus on a plurality of biometric information units and capture a clear image, possible to perform a plurality of authentication operations such as iris authentication, fingerprint authentication, and vein authentication simultaneously, and in addition possible to realize high precision authentication and possible to reduce an erroneous authentication rate.

According to the present invention, with a simple configuration, it is possible to flexibly cope with a change of size of the biometric authenticated part, possible to easily focus on a fingerprint or vein or other blood vessel patterns and capture a clear image, possible to prevent forgery, and in addition possible to realize high precision authentication. Further, only the least required level of authentication need be carried out.

Further, there are the advantages that the lenses can be designed without regard as to the object distance and defocus range and that image restoration by convolution and other high precision operations becomes possible.

Further, according to the present invention, the optical system can be simplified, and the cost can be reduced.

### BRIEF DESCRIPTION OF THE DRAWINGS

FIG. 1 is a diagram schematically showing the configuration of a general imaging lens apparatus and a state of light beams.

FIG. 2A to FIG. 2C are diagrams showing spot images on a light receiving surface of an imaging element of the imaging lens apparatus of FIG. 1, in which FIG. 2A is a diagram showing a spot image in a case where a focal point is deviated by 0.2 mm (defocus=0.2 mm), FIG. 2B is a diagram showing a spot image in a case of focus (best focus), and FIG. 2C is a diagram showing a spot image in a case where the focal point is deviated by −0.2 mm (defocus=−0.2 mm).

FIG. 3 is a diagram schematically showing an example of the configuration of a biometric authentication apparatus according to a first embodiment of the present invention.

FIG. 4 is a diagram schematically showing a fingerprint authentication operation in the biometric authentication apparatus of FIG. 3.

FIG. 5 is a diagram schematically showing a vein authentication operation in the biometric authentication apparatus of FIG. 3.

FIG. 6 is a block diagram showing the configuration of an image capturing apparatus according to the present embodiment.

FIG. 7 is a diagram schematically showing an example of the configuration of a zoom optical system of an imaging lens apparatus according to the present embodiment.

FIG. 8 is a diagram showing the spot image on an infinite side of a zoom optical system not including a phase plate.

FIG. 9 is a diagram showing the spot image on a proximate side of a zoom optical system not including a phase plate.

FIG. 10 is a diagram showing the spot image on an infinite side of a zoom optical system including a phase plate.

FIG. 11 is a diagram showing the spot image on a proximate side of a zoom optical system including a phase plate.

FIG. 12 is a block diagram showing a concrete example of the configuration of an image processing apparatus of the present embodiment.

FIG. 13 is a diagram for explaining a principle of a wavefront aberration control optical system.

FIG. 14 is a flow chart for explaining an operation of the present embodiment.

FIG. 15A to FIG. 15C are diagrams showing spot images on the light receiving surface of an imaging element of an imaging lens apparatus according to the present embodiment, in which FIG. 15A is a diagram showing a spot image in the case where the focal point is deviated by 0.2 mm (defocus=0.2 mm), FIG. 15B is a diagram showing a spot image in the case of focus (best focus), and FIG. 15C is a diagram showing a spot image in the case where the focal point is deviated by −0.2 mm (defocus=−0.2 mm).

FIG. 16A and FIG. 16B are diagrams for explaining an MTF of a first order image formed by an imaging lens apparatus according to the present embodiment, in which FIG. 16A is a diagram showing a spot image on the light receiving surface of an imaging element of an imaging lens apparatus, and FIG. 16B shows an MTW characteristic with respect to a spatial frequency.

FIG. 17 is a diagram for explaining MTF correction processing in an image processing apparatus according to the present embodiment.

FIG. 18 is a diagram for concretely explaining MTF correction processing in an image processing apparatus according to the present embodiment.

FIG. 19 is a diagram showing the response of the MTF at a time when an object is located at a focal point position and a time when the object deviates from the focal point position in a case of the usual optical system.

FIG. 20 is a diagram showing the response of the MTF at the time when an object is located at a focal point position and a time when the object deviates from the focal point position in a case of the optical system of the present embodiment having an optical wavefront modulation element.

FIG. 21 is a diagram showing the response of the MTF after data restoration of the image capturing apparatus according to the present embodiment.

FIG. 22 is a flow chart for explaining the operation of a biometric authentication apparatus of the present embodiment.

FIG. 23 is a diagram schematically showing an example of the configuration of a biometric authentication apparatus according to a second embodiment of the present invention.

FIG. 24 is a diagram schematically showing a fingerprint authentication operation in the biometric authentication apparatus of FIG. 23.

FIG. 25 is a diagram schematically showing a vein authentication operation in the biometric authentication apparatus of FIG. 23.

FIG. 26 is a flow chart for explaining an iris and fingerprint authentication operation in the biometric authentication apparatus of the second embodiment.

FIG. 27 is a flow chart for explaining a fingerprint and vein authentication operation in the biometric authentication apparatus of the present second embodiment.

FIG. 28 is a diagram schematically showing a biometric authentication apparatus according to a third embodiment of the present invention.

FIG. 29 is a diagram showing an example of the configuration of an optical system combining a wide angle optical system, a telephoto optical system, and a prism.

FIG. 30A and FIG. 30B are diagrams showing an example of arrangement of optical wavefront modulation elements with respect to the prism in the configuration of FIG. 29.

FIG. 31 is a diagram schematically showing a biometric authentication apparatus according to a fourth embodiment of the present invention.

FIG. 32A and FIG. 32B are diagrams showing an example of a configuration providing a group of moveable reflection plates as an information introduction unit in an optical system having a wide angle optical system and a telephoto optical system.

FIG. 33A and FIG. 33B are diagrams showing an example of a configuration providing a group of moveable optical wavefront modulation elements as an information introduction unit in an optical system having a wide angle optical system and a telephoto optical system.

FIG. 34 is a schematic diagram showing making a size of a hand a certain specific size.

FIG. 35 is a diagram for explaining a fifth embodiment and shows a state where a hand to be captured is captured at the same size by moving the optical system and changing a magnification according to a location at which the fingers of the hand constituting an object OBJ are held aloft.

FIG. 36 is a diagram for explaining the fifth embodiment and shows a state where a hand to be captured is captured at the same size by moving the optical system and changing the magnification according to a location at which the fingers of the hand constituting the object OBJ are held aloft.

FIG. 37A and FIG. 37B are diagrams for explaining the fifth embodiment and show the relationships between the size of the hand and pixels at the time of the capture in a case where an image capturing apparatus having a zoom optical system is used.

FIG. 38 is a diagram for explaining the fifth embodiment and shows a configuration in which an optical wavefront modulation element is inserted into the configuration shown in FIG. 36 and FIG. 37 and simultaneously shows that the capture of the veins of a palm is enabled as well.

FIG. 39 is a diagram showing a schematic flow of operation of the capture and lens movement after the authentication in the fifth embodiment is started.

FIG. 40 is a diagram schematically showing an example of the configuration of a biometric authentication apparatus according to a sixth (seventh) embodiment of the present invention.

FIG. 41 is a schematic diagram showing the size of an image at a point of time when reference authentication data is registered for explaining the sixth embodiment and shows the size of the object image at the time of registration.

FIG. 42 is a schematic diagram showing the size of an image at a point of time when reference authentication data is registered for explaining the sixth embodiment and shows a state at the time of registration by the image capturing apparatus of the present embodiment.

FIG. 43 is a diagram for explaining the sixth embodiment and shows the size at the time of a provisional capture (no change of magnification) and the size at the time of true capture (time of authentication) (after change of magnification).

FIG. 44 is a diagram for explaining the sixth embodiment and shows a state where an inspected object is further away than that at the time of registration.

FIG. 45 is a diagram for explaining the sixth embodiment and shows a state at the time of authentication (time of capture) (after change of magnification).

FIG. 46 is a diagram showing a configuration in which an optical wavefront modulation element is inserted into the configuration of a magnification change optical system for explaining the sixth embodiment and shows that the capture of the veins of a palm is simultaneously made possible as well.

FIG. 47 is a flow chart showing a schematic operation at the time of registration of reference authentication data in the sixth embodiment.

FIG. 48 is a diagram showing a schematic flow of operation of the capture and lens movement after the authentication in the sixth embodiment is started.

FIG. 49A and FIG. 49B are examples showing positions to be authenticated of the hand, here, schematic diagrams showing the forefinger pad, middle finger pad, third finger pad, pinky pad, and the palm divided into 16 sections.

FIG. 50A to FIG. 50C are diagrams showing representative patterns of fingerprints.

FIG. 51A to FIG. 51D are diagrams showing examples of the fingerprint patterns of one person.

FIG. 52 is a diagram for explaining a seventh embodiment and shows that the image capturing can be carried out in a state where a resolution is high.

FIG. 53 is a diagram for explaining the seventh embodiment and shows an example where the resolution is lowered since the location where the hand is held aloft is far away.

FIG. 54A and FIG. 54B are diagrams showing setting authentication levels by combinations of fingerprints.

FIG. 55 is a diagram showing an example of replacing the authentication by a fingerprint by vein authentication.

FIG. 56 is a diagram showing a configuration where an optical wavefront modulation element is inserted into the configuration of a magnification change optical system and shows that capture of the veins of the palm is simultaneously made possible.

### DESCRIPTION OF NOTATIONS

100, 100A, 100B . . . biometric authentication apparatuses, 110 . . . transparent substrate, 120 . . . illumination apparatus for capturing fingerprint, 130 . . . illumination apparatus for capturing veins, 140 . . . image capturing apparatus, 200 . . . imaging lens apparatus, 211 . . . object side lens, 212 . . . image formation lens, 213 . . . wavefront coding optical element, 213a . . . phase plate, 300 . . . image processing apparatus, 301 . . . convolution apparatus, 302 . . . kernel and/or numerical value processing coefficient storage register, 303 . . . image processing computation processor, 400 . . . object approximate distance information detection apparatus, 500, 500A, 500B . . . biometric authentication apparatuses, 510 . . . first information acquisition unit, 520 . . . second information acquisition unit, 530 . . . light path formation unit, and 540 . . . image capturing apparatus.

### BEST MODE FOR CARRYING OUT THE INVENTION

Below, embodiments of the present invention will be explained with reference to the accompanying drawings.

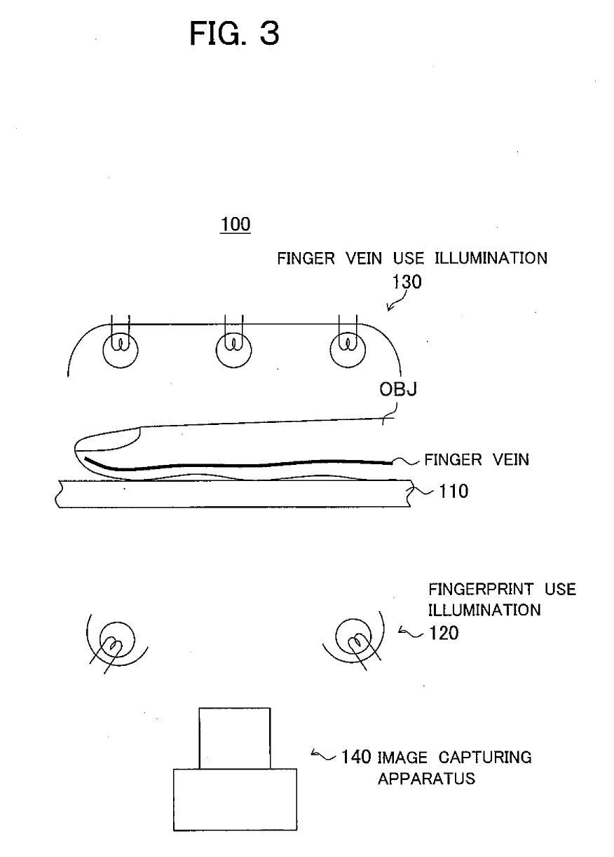

FIG. 3 is a diagram schematically showing an example of the configuration of a biometric authentication apparatus according to a first embodiment of the present invention.

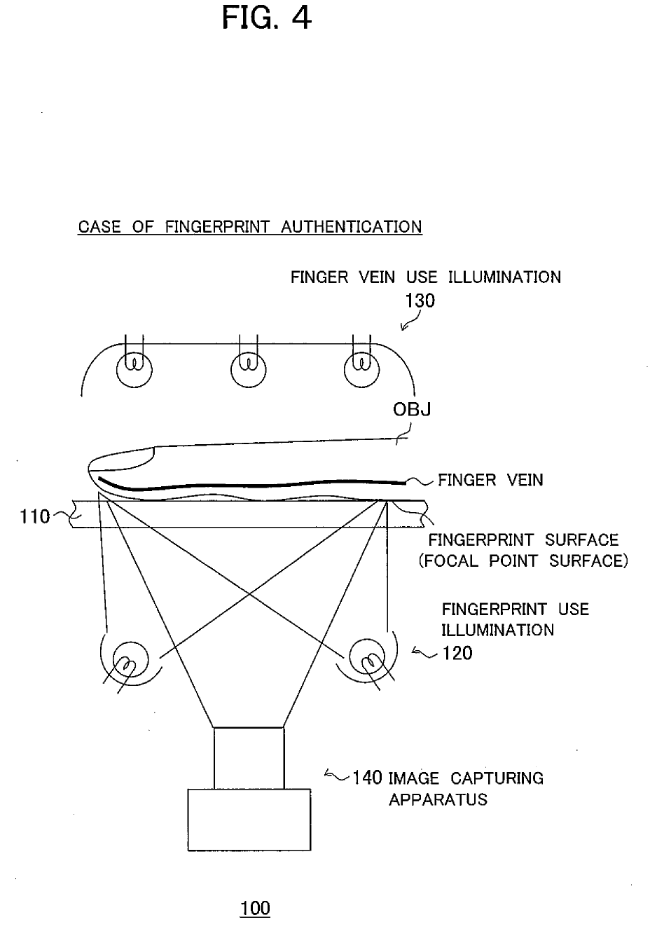

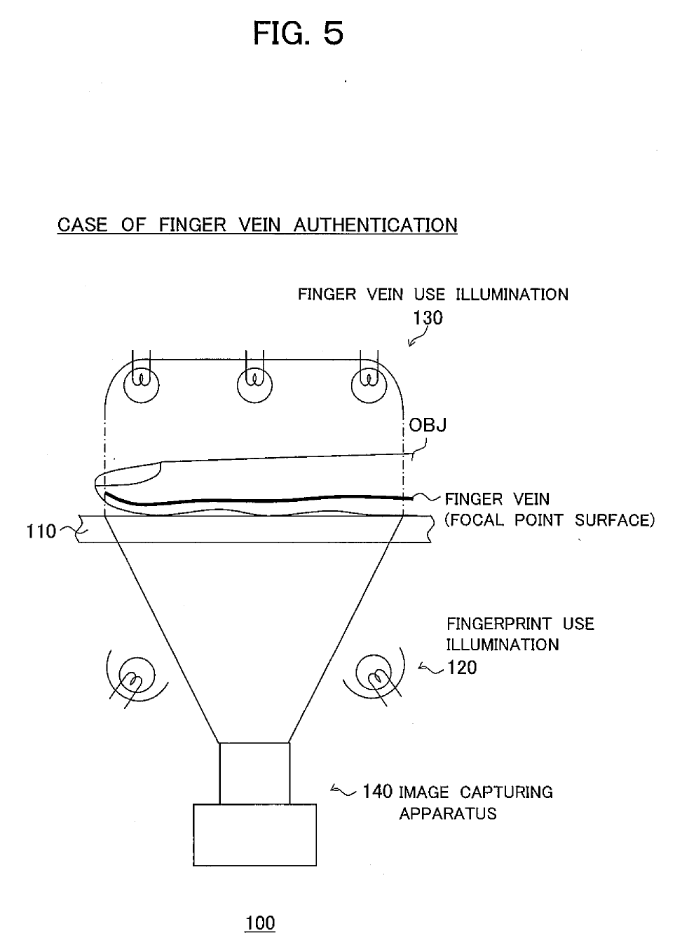

Further, FIG. 4 is a diagram schematically showing a fingerprint authentication operation in the biometric authentication apparatus according to the present embodiment, and FIG. 5 is a diagram schematically showing a vein authentication operation in the biometric authentication apparatus according to the present embodiment.

The present biometric authentication apparatus 100, as shown in FIG. 3, has a transparent plate 110 formed by for example glass or plastic for placement of the finger of the authenticated person, that is, the inspected specimen OBJ, downward in the figure (surface where fingerprint is located facing downward), a fingerprint capturing use illumination apparatus 120, a vein capturing use illumination apparatus 130, and an image capturing apparatus 140 as principal components.

In the biometric authentication apparatus 100, as shown in FIG. 3 and FIG. 4, the image capturing apparatus 140 is arranged at the side of the front surface of the inspected specimen OBJ (surface where palm print is located), and the illumination apparatus 120 is arranged on the same side for the purpose of assisting the capture of the fingerprint.

Further, as shown in FIG. 3 and FIG. 5, the illumination apparatus 130 is arranged on the side of the back surface of the inspected specimen OBJ (surface where fingernails are located) for the purpose of assisting the capture of the veins.

The illumination apparatuses are not referred here in detail. Preferably, as the fingerprint capturing use illumination apparatus 120, use is made of visible light or a light source having a wavelength suitable for further highlighting a fingerprint. As the vein capturing use illumination apparatus 130, use is made of a light source suitable for passing through the skin and highlighting the blood vessels, for example, a light source emitting infrared rays.

The image capturing apparatus 140, as will be explained in detail later, has a field depth enlarging optical system having an optical wavefront modulation element and an image processing unit and configured so that it can output a restored image.

The image capturing apparatus 140 includes a storage unit for temporarily storing the image data, a data conversion unit for comparing and collating image data, a storage unit of data registered in the other, a processing unit for performing the comparison and collation, and further an instruction unit issuing an instruction in accordance with results of the comparison and collation.

Note that here the explanation is given taking as an example a case where the apparatus is shown alone, but a configuration for handling a network utilizing a dedicated line, Internet, etc. is possible as well. In that case, the system configuration becomes one having a server where the registered data becomes the host of the network.

By employing the image capturing apparatus 140 provided with the field depth enlarging optical system having the optical wavefront modulation element and the image processing unit as in the present embodiment, it is possible to obtain the following characteristic features.

In the usual optical system, it becomes necessary to make the stop small, that is, dark, in order to obtain the field depth.

Contrary to this, in the “depth enlarging optical system” of the present embodiment explained in detail later, it also becomes unnecessary to make the stop small, therefore, the amount of required light becomes smaller in comparison with the usual optical system. Accordingly, the amount of light of the illumination apparatus can be reduced.

This makes it possible to reduce the cost of the illumination apparatus and reduce the power consumption. As a result, the durability of the illumination apparatus can be improved.

On the other hand, a focused image can be obtained even when the location where the inspected specimen is placed is not a constant point, therefore authentication without touching an apparatus becomes possible although a certain range must be set.

Further, in the biometric authentication apparatus 100 of the present embodiment, the priority order of the plurality of authentication results can be switched in accordance with the situation.

As the switching method of the priority order of the authentication and collation, for example a method of collating the captured data with the registered data and switching the priority order based on that collation result can be employed. Further, as another method, a method where the user (subject) makes the selection when performing the authentication can be employed as well.

In the present embodiment, in for example a case where the authentication precision of a fingerprint becomes low due to injury, dirt, or the like, the vein authentication is given a higher priority.

Conversely, it is possible to employ a method giving a higher priority to the fingerprint authentication in a state where the temperature of the inspected specimen greatly changes, for example a case where the subject becomes cold and in that case his or her flow of blood becomes bad or a case where the authentication precision becomes low due to an injury etc.

Note that, here, the switching of the priority order means adjustment by weighting each authentication in advance and is different from employing just one authentication result.

Due to this, the authentication rate can be improved over one authentication operation, and authentication having a high precision becomes possible without lowering the authentication rate due to the plurality of authentication operations.

Below, a detailed explanation will be given of the image capturing apparatus 140 provided with a field depth enlarging optical system having an optical wavefront modulation element and an image processing unit.

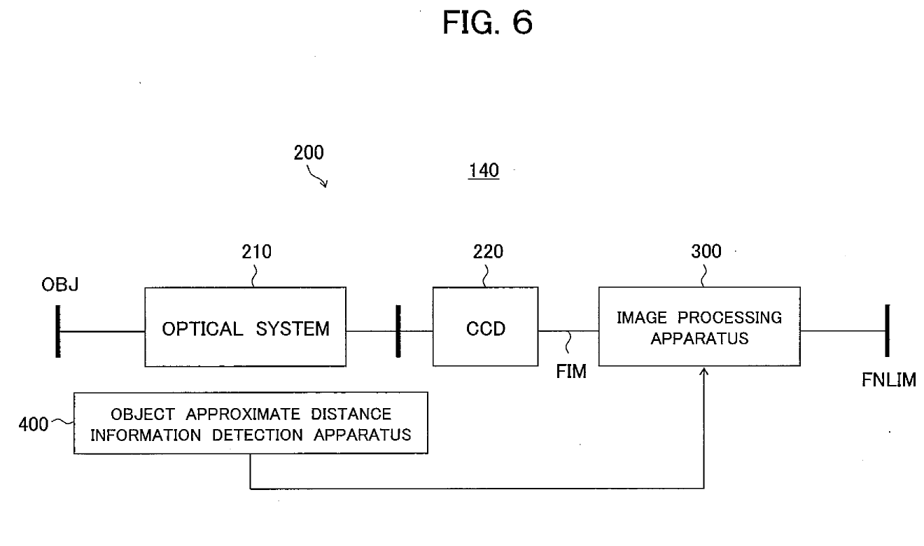

FIG. 6 is a block diagram showing the configuration of an image capturing apparatus according to the present embodiment.

The image capturing apparatus 140 according to the present embodiment has an imaging lens apparatus 200 having a zoom optical system, an image processing apparatus 300, and an object approximate distance information detection apparatus 400 as principal components. Note that, in the present embodiment, the location of the inspected specimen OBJ is at an approximately constant location, therefore it is not always necessary to provide the object approximate distance information detection apparatus 400.

The imaging lens apparatus 200 has a zoom optical system 210 for optically capturing an image of an imaging object (object) OBJ, and an imaging element 220 formed by an CCD or CMOS sensor at which the image captured at the zoom optical system 210 is imaged and which outputs an imaged first order image information as a first order image signal FIM of an electric signal to the image processing apparatus 300. In FIG. 6, the imaging element 220 is described as a CCD as an example.

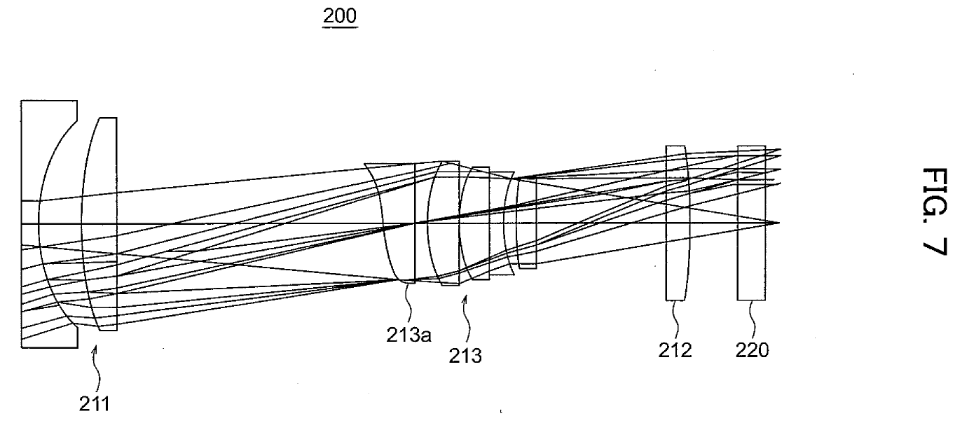

FIG. 7 is a diagram schematically showing an example of the configuration of the optical system of the zoom optical system 210 according to the present embodiment.

The zoom optical system 210 of FIG. 7 has an object side lens 211 arranged on the object side OBJS, an image formation lens 212 for forming an image in the imaging element 220, and an optical wavefront modulation element (wavefront coding optical element) group 213 arranged between the object side lens 211 and the image formation lens 212 and comprising phase plates (cubic phase plates) deforming the wavefront of the image formed on the light receiving surface of the imaging element 220 by the image formation lens 212 and having for example three-dimensional curved surfaces. Further, a not shown stop is arranged between the object side lens 211 and the image formation lens 212.

Note that, in the present embodiment, an explanation was given of the case where phase plates were used, but the optical wavefront modulation elements of the present invention may include any elements so far as they deform the wavefront. They may include optical elements changing in thickness (for example, the above-explained third order phase plates), optical elements changing in refractive index (for example, refractive index distribution type wavefront modulation lenses), optical elements changing in thickness and refractive index by coding on the lens surface (for example, wavefront coding hybrid lenses), liquid crystal elements able to modulate the phase distribution of the light (for example, liquid crystal spatial phase modulation elements), and other optical wavefront modulation elements.

The zoom optical system 210 of FIG. 7 is an example of inserting an optical phase plate 213a into a 3× zoom system used in a digital camera.

The phase plate 213a shown in the figure is an optical lens regularly dispersing the light beams converged by the optical system. By inserting this phase plate, an image not focused anywhere on the imaging element 220 is realized.

In other words, the phase plate 213a forms light beams having a deep depth (playing a central role in the image formation) and a flare (blurred portion).

The means for restoring this regularly dispersed image to a focused image by digital processing will be referred to as a “wavefront aberration control optical system”. This processing is carried out in the image processing apparatus 300.

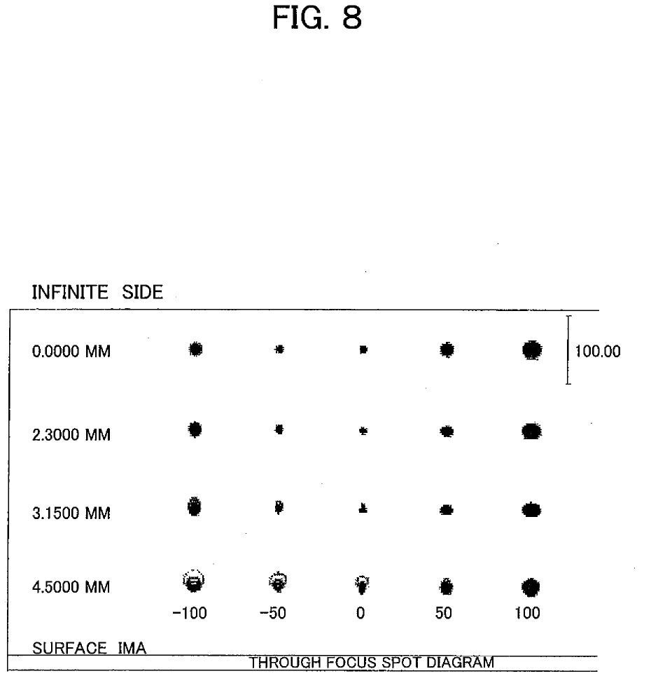

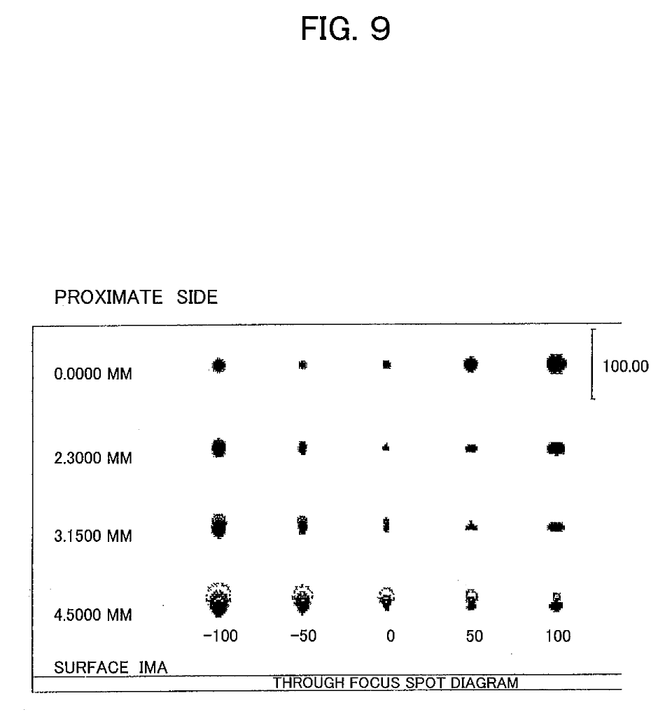

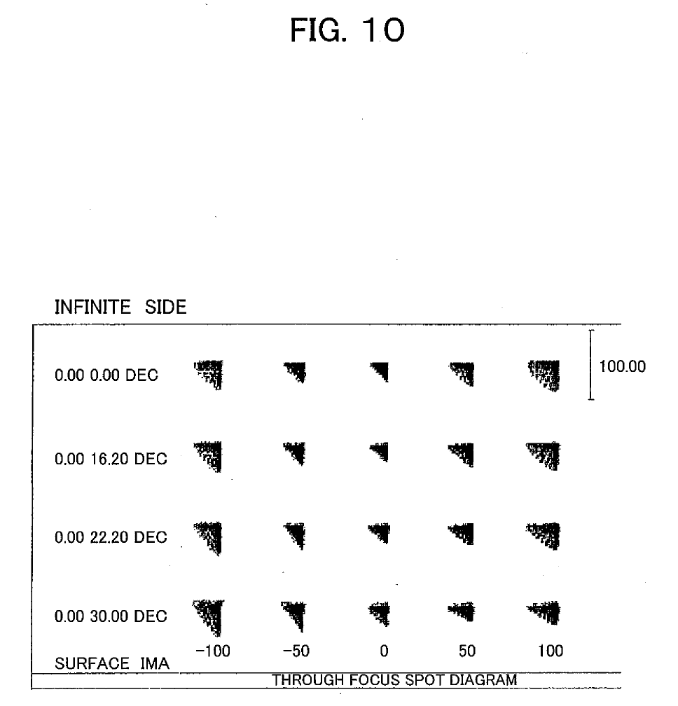

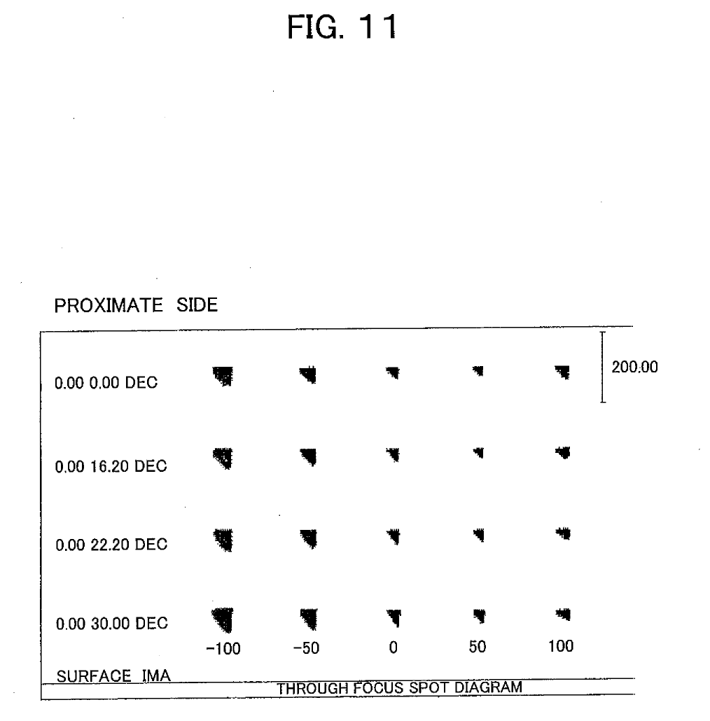

FIG. 8 is a diagram showing a spot image on the infinite side of a zoom optical system 210 not including a phase plate. FIG. 9 is a diagram showing a spot image on the proximate side of a zoom optical system 210 not including a phase plate. FIG. 10 is a diagram showing a spot image on the infinite side of a zoom optical system 210 including a phase plate. FIG. 11 is a diagram showing the spot image on the proximate side of a zoom optical system 210 including a phase plate.

Basically, the spot image of light passing through an optical lens system not including a phase plate, as shown in FIG. 8 and FIG. 9, differs between the case where the object distance thereof is at the proximate side and the case where it is at the infinite side.

In this way, in an optical system having a spot image differing according to the object distance, an H function explained later is different.

Naturally, as shown in FIG. 10 and FIG. 11, a spot image passed through the phase plate influenced by this spot image also differs between the case where the object position is at the proximate side and the case where it is at the infinite side.

In an optical system having such a spot image differing according to the object position, suitable convolution processing cannot be performed in a conventional apparatus. Therefore, an optical design eliminating astigmatism, coma aberration, spherical aberration, and other aberration is required. However, an optical design for eliminating these aberrations increases the difficulty of the optical design and causes the problems of an increase of the number of design processes, a cost increase, and an increase of the size of the lenses.

Therefore, in the present embodiment, as shown in FIG. 6, at the point of time when the image capturing apparatus (camera) 140 enters into the imaging state, the approximate distance of the object distance of the object is read out from the object approximate distance information detection apparatus 400 and supplied to the image processing apparatus 300.

The image processing apparatus 300 generates a dispersion-free image signal from the dispersed image signal from the imaging element 220 based on the approximate distance information of the object distance of the object read out from the object approximate distance information detection apparatus 400.

The object approximate distance information detection apparatus 400 may be an AF sensor such as external active sensor.

Note that, in the present embodiment, “dispersion” means the phenomenon where, as explained above, inserting the phase plate 213a causes the formation of an image not focused anywhere on the imaging element 220 and the formation of light beams having a deep depth (playing a central role in the image formation) and flare (blurred portion) by the phase plate 213a and includes the same meaning as aberration because of the behavior of the image being dispersed and forming a blurred portion. Accordingly, in the present embodiment, there also exists a case where dispersion is explained as aberration.

FIG. 12 is a block diagram showing an example of the configuration of the image processing apparatus 300 for generating a dispersion-free signal from a dispersed image signal from the imaging element 220.

The image processing apparatus 300, as shown in FIG. 12, has a convolution apparatus 301, a kernel and/or numerical value processing coefficient storage register 302, and an image operational computation processor 303.

In this image processing apparatus 300, the image processing computation processor 303 obtaining information concerning the approximate distance of the object distance of the object read out from the object approximate distance information detection apparatus 400 stores the kernel size and its operational coefficients used in suitable operation with respect to the object distance position in the kernel and/or numerical value operational coefficient storage register 302 and performs the suitable operation at the convolution apparatus 301 by using those values for operation to restore the image.

Here, the basic principle of the wavefront aberration control optical system will be explained.

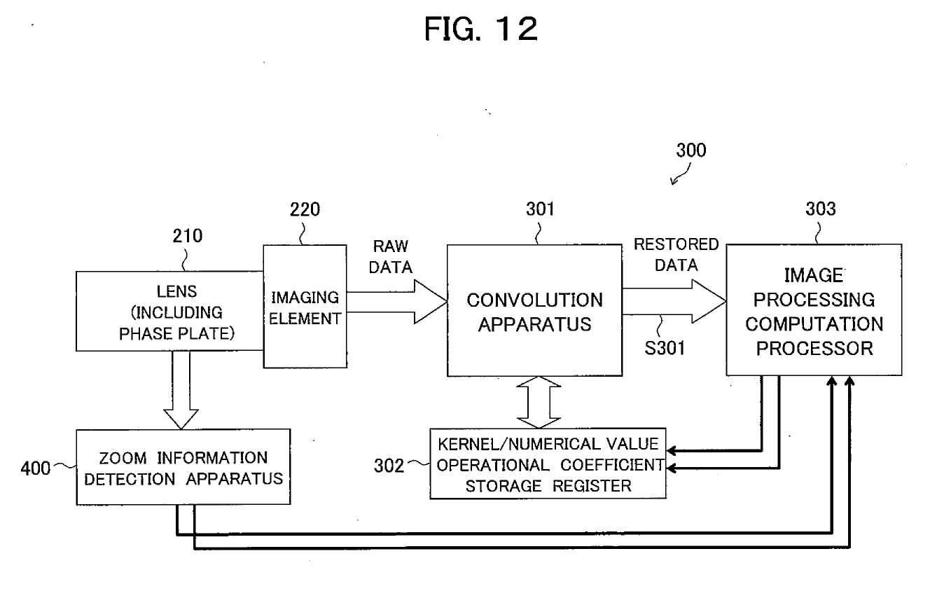

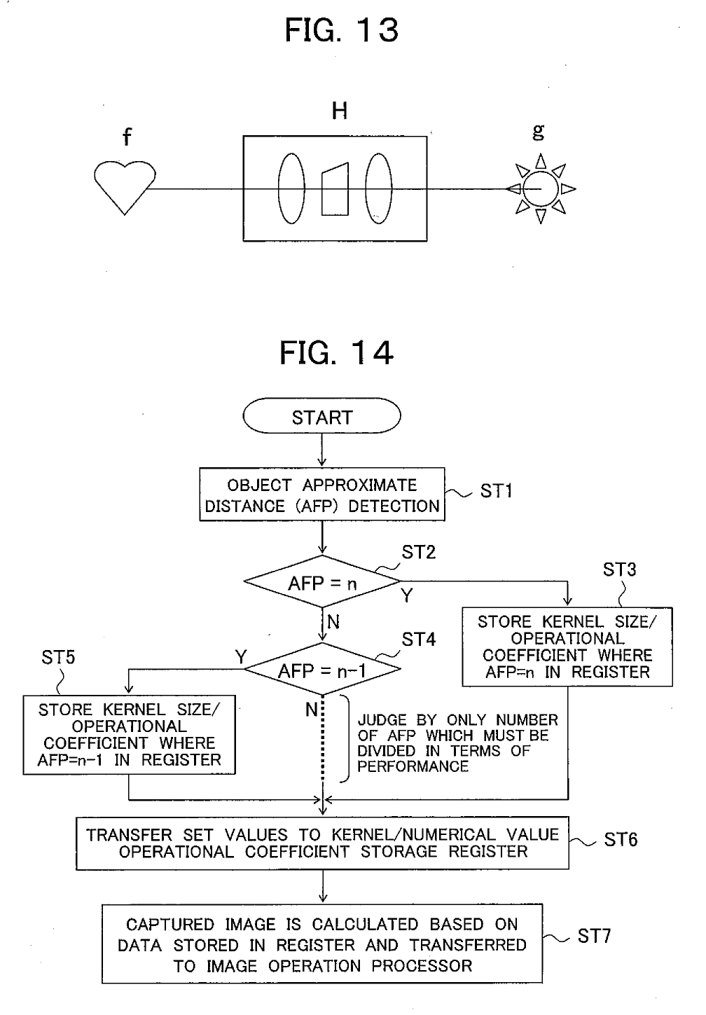

As shown in FIG. 13, an image f of the object enters into an optical system H of the wavefront aberration control optical system, whereby an image g is generated.

This can be represented by the following equation.

g=H*f (Equation 1)

where, * indicates convolution.

In order to find the object from the generated image, the next processing is required.

f=H⁻¹*g (Equation 2)

Here, the kernel size and operational coefficients concerning the function H will be explained.

Assume that the individual object approximate distances are AFPn, AFPn−1, . . . , and assume the individual zoom positions are Zpn, Zpn−1, . . . .

Assume that the H functions thereof are Hn, Hn−1, . . . .

The spots are different, therefore the H functions become as follows.

$$Hn = ( \begin{matrix}a & b & c \\ d & e & f\end{matrix} ) \\ Hn - 1 = ( \begin{matrix}{a}^{′} & {b}^{′} & {c}^{′} \\ {d}^{′} & {e}^{′} & {f}^{′} \\ {g}^{′} & {h}^{′} & {i}^{′}\end{matrix} ) \qquad [ Equation 3 ]$$

The difference of the number of rows and/or the number of columns of this matrix is referred to as the “kernel size”. The numbers are the operational coefficients.

As explained above, in the case of an image capturing apparatus provided with a phase plate (wavefront coding optical element) as an optical wavefront modulation element, if within a predetermined focal distance range, a suitable aberration-free image signal can be generated by image processing concerning that range, but if out of the predetermined focal length range, there is a limit to the correction of the image processing, therefore only an object out of the above range ends up becoming an image signal with aberration.

Further, on the other hand, by applying image processing not causing aberration within a predetermined narrow range, it also becomes possible to give blurriness to an image out of the predetermined narrow range.

The present embodiment is configured so as to detect the distance up to the main object by the object approximate distance information detection apparatus 400 including the distance detection sensor and perform processing for image correction different in accordance with the detected distance.

The above image processing is carried out by convolution operation. In order to accomplish this, for example, it is possible to commonly storing one type of operational coefficient of the convolution operation, store in advance a correction coefficient in accordance with the focal length, correct the operational coefficient by using this correction coefficient, and perform suitable convolution processing by the corrected operational coefficient.

Other than this configuration, it is possible to employ the following configurations.

It is possible to employ a configuration storing in advance the kernel size and the operational coefficient itself of the convolution in accordance with the focal length and perform a convolution operation by these stored kernel size and operational coefficient, a configuration storing in advance the operational coefficient in accordance with a focal length as a function, finding the operational coefficient by this function according to the focal length, and performing the convolution operation by the calculated operational coefficient, and so on.

When linked with the configuration of FIG. 12, the following configuration can be employed.

At least two conversion coefficients corresponding to the aberration due to at least the phase plate 213a are stored in advance in the register 302 as the conversion coefficient storing means in accordance with the object distance. The image processing computation processor 303 functions as the coefficient selecting means for selecting a conversion coefficient in accordance with the distance up to the object from the register 302 based on the information generated by the object approximate distance information detection apparatus 400 as the object distance information generating means.

Then, the convolution apparatus 301 serving as the converting means converts the image signal according to the conversion coefficient selected at the image processing computation processor 303 serving as the coefficient selecting means.

Alternatively, as explained above, the image processing computation processor 303 serving as the conversion coefficient processing means computes the conversion coefficient based on the information generated by the object approximate distance information detection apparatus 400 serving as the object distance information generating means and stores the same in the register 302.

Then, the convolution apparatus 301 serving as the converting means converts the image signal according to the conversion coefficient obtained by the image processing computation processor 303 serving as the conversion coefficient computation means and stored in the register 302.

Alternatively, at least one correction value in accordance with the zoom position or zoom amount of the zoom optical system 210 is stored in advance in the register 302 serving as the correction value storing means. This correction value includes the kernel size of the object aberration image.

The register 302, functioning also as the second conversion coefficient storing means, stores in advance the conversion coefficient corresponding to the aberration due to the phase plate 213a.

Then, based on the distance information generated by the object approximate distance information detection apparatus 400 serving as the object distance information generating means, the image processing computation processor 303 serving as the correction value selecting means selects the correction value in accordance with the distance up to the object from the register 302 serving as the correction value storing means.

The convolution apparatus 301 serving as the converting means converts the image signal based on the conversion coefficient obtained from the register 302 serving as the second conversion coefficient storing means and the correction value selected by the image processing computation processor 303 serving as the correction value selecting means.

Next, the concrete processing of the case where the image processing computation processor 303 functions as the conversion coefficient operation means will be explained with reference to the flow chart of FIG. 14.

The object approximate distance information detection apparatus 400 detects the object approximate distance (AFP) and supplies the detection information to the image processing computation processor 303 (ST1). The image processing computation processor 303 judges whether or not the object approximate distance AFP is n (ST2).

When it is judged at step ST1 that the object approximate distance AFP is n, the kernel size and operational coefficient where AFP=n are found and stored in the register (ST3).

When it is judged at step ST2 that the object approximate distance AFP is not n, it is judged whether or not the object approximate distance AFP is n−1 (ST4).

When it is judged at step ST4 that the object approximate distance AFP is n−1, the kernel size and operational coefficient where AP=n−1 are found and stored in the register (ST5).

After this, the judgment processing of steps ST2 and ST4 is carried out for exactly the number of the object approximate distance AFPs which must be divided into in terms of performance, and the kernel sizes and the operational coefficients are stored in the register.

The image processing computation processor 303 transfers the set values to the kernel and/or numerical value processing coefficient storage register 302 (ST6).

Then, the image data captured at the imaging lens apparatus 200 and input to the convolution apparatus 301 is processed by a convolution operation based on the data stored in the register 302, and the processed and converted data S302 is transferred to the image processing computation processor 303 (ST7).

In the present embodiment, the wavefront aberration control optical system is employed and a high definition image quality can be obtained. In addition, the optical system can be simplified, and the cost can be reduced.

Below, these characteristic features will be explained.

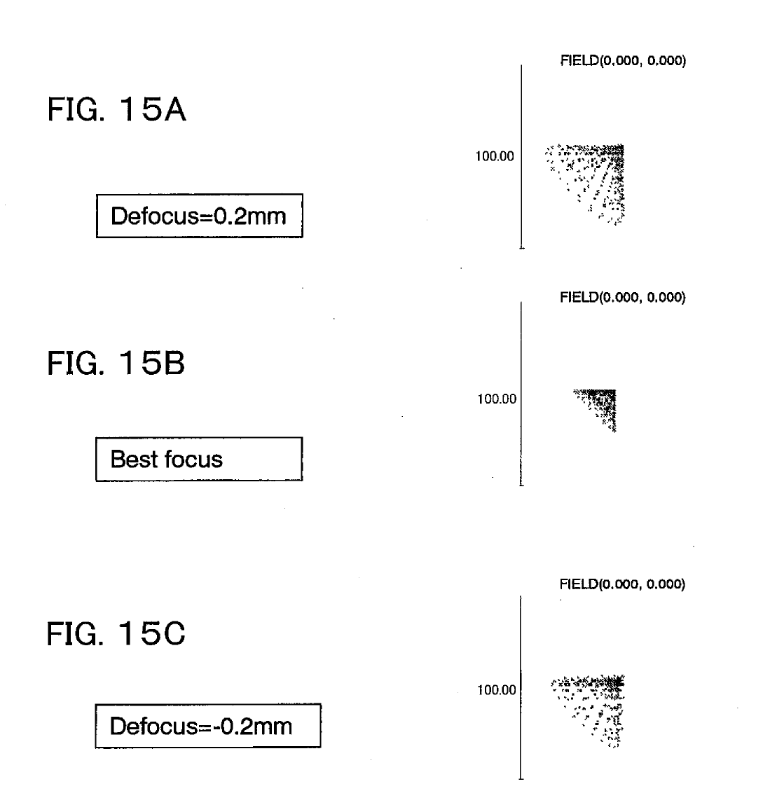

FIG. 15A to FIG. 15C show spot images on the light reception surface of the imaging element 220 of the imaging lens apparatus 200.

FIG. 15A is a diagram showing a spot image in the case where the focal point is deviated by 0.2 mm (defocus=0.2 mm), FIG. 15B is a diagram showing a spot image in the case of focus (best focus), and FIG. 15C is a diagram showing a spot image in the case where the focal point is deviated by −0.2 mm (defocus=−0.2 mm).

As seen also from FIG. 15A to FIG. 15C, in the imaging lens apparatus 200 according to the present embodiment, light beams having a deep depth (playing a central role in the image formation) and a flare (blurred portion) are formed by the wavefront coding optical element group 213 including the phase plate 213a.

In this way, the first order image FIM formed in the imaging lens apparatus 200 of the present embodiment is given light beam conditions resulting in deep depth.

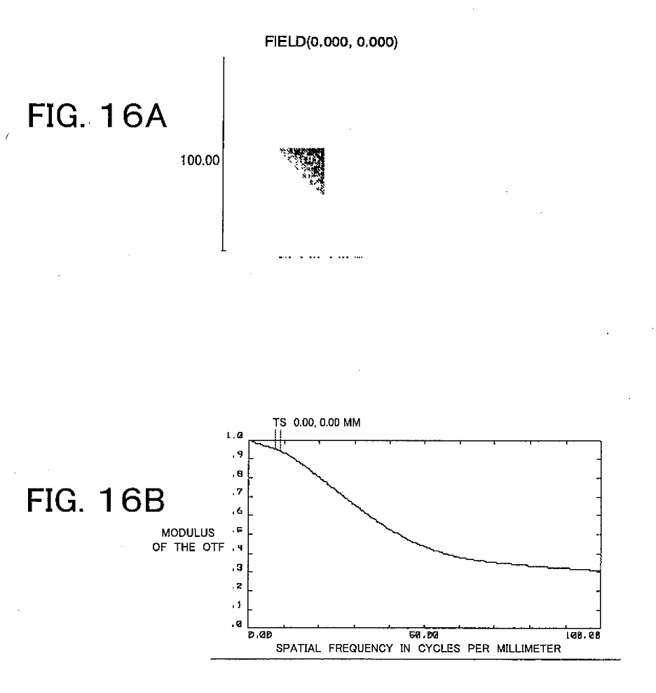

FIG. 16A and FIG. 16B are diagrams for explaining a modulation transfer function (MTF) of the first order image formed by the imaging lens apparatus according to the present embodiment, in which FIG. 16A is a diagram showing a spot image on the light receiving surface of the imaging element of the imaging lens apparatus, and FIG. 16B shows the MTF characteristic with respect to the spatial frequency.

In the present embodiment, the high definition final image is left to the correction processing of the later image processing apparatus 300 configured by, for example, a digital signal processor. Therefore, as shown in FIG. 16A and FIG. 16B, the MTF of the first order image essentially becomes a very low value.

The image processing apparatus 300 is configured by for example a DSP and, as explained above, receives the first order image FIM from the imaging lens apparatus 200, applies predetermined correction processing etc. for boosting the MTF at the spatial frequency of the first order image, and forms a high definition final image FNLIM.

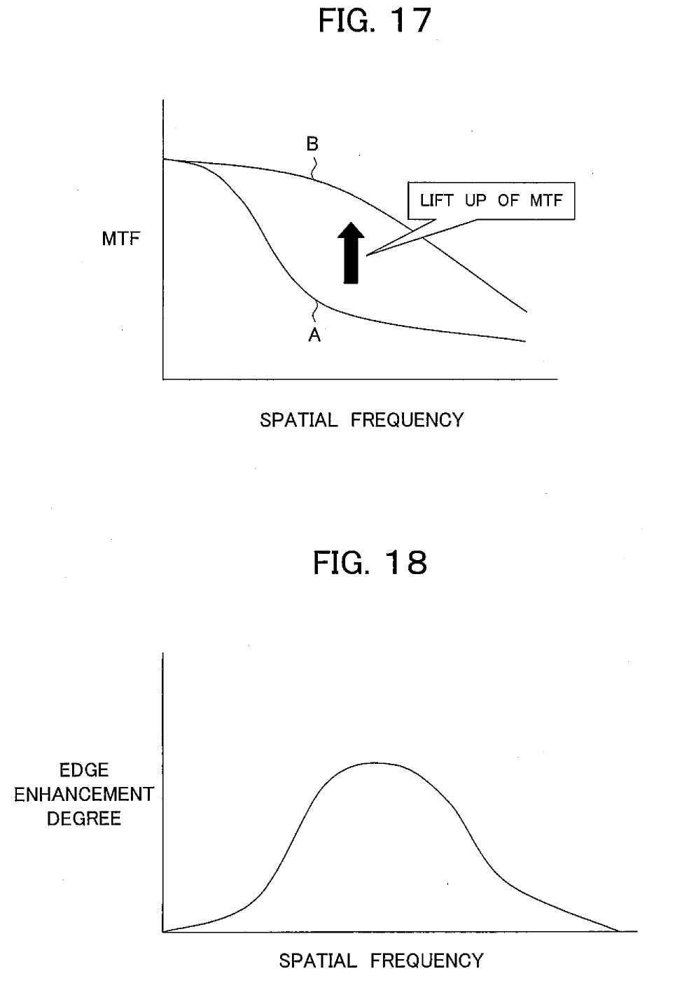

The MTF correction processing of the image processing apparatus 300 performs correction so that, for example as indicated by a curve A of FIG. 17, the MTF of the first order image which essentially becomes a low value approaches (reaches) the characteristic indicated by a curve B in FIG. 17 by post-processing such as edge enhancement and chroma enhancement by using the spatial frequency as a parameter.

The characteristic indicated by the curve B in FIG. 17 is the characteristic obtained in the case where the wavefront coding optical element is not used and the wavefront is not deformed as in for example the present embodiment.

Note that all corrections in the present embodiment are according to the parameter of the spatial frequency.

In the present embodiment, as shown in FIG. 17, in order to achieve the MTF characteristic curve B desired to be finally realized with respect to the MTF characteristic curve A for the optically obtained spatial frequency, the strength of the edge enhancement etc. is adjusted for each spatial frequency, to correct the original image (first order image).

For example, in the case of the MTF characteristic of FIG. 17, the curve of the edge enhancement with respect to the spatial frequency becomes as shown in FIG. 18.

Namely, by performing the correction by weakening the edge enhancement on the low frequency side and high frequency side within a predetermined bandwidth of the spatial frequency and strengthening the edge enhancement in an intermediate frequency zone, the desired MTF characteristic curve B is virtually realized.

In this way, the image capturing apparatus 140 according to the embodiment is an image forming system configured by the imaging lens apparatus 200 including the optical system 210 for forming the first order image and the image processing apparatus 300 for forming the first order image to a high definition final image, wherein the optical system is newly provided with a wavefront coding optical element or is provided with a glass, plastic, or other optical element with a surface shaped for wavefront forming use so as to deform the wavefront of the image formed, such a wavefront is imaged onto the imaging surface (light receiving surface) of the imaging element 220 formed by a CCD or CMOS sensor, and the imaged first order image is passed through the image processing apparatus 300 to obtain the high definition image.

In the present embodiment, the first order image from the imaging lens apparatus 200 is given light beam conditions with very deep depth. For this reason, the MTF of the first order image inherently becomes a low value, and the MTF thereof is corrected by the image processing apparatus 300.

Here, the process of image formation in the imaging lens apparatus 200 of the present embodiment will be considered in terms of wave optics.

A spherical wave scattered from one point of an object point becomes a converged wave after passing through the image formation optical system. At that time, when the image formation optical system is not an ideal optical system, aberration occurs. The wavefront becomes not spherical, but a complex shape. Geometric optics and wave optics are bridged by wavefront optics. This is convenient in the case where a wavefront phenomenon is handled.

When handling a wave optical MTF on an imaging plane, the wavefront information at an exit pupil position of the image formation optical system becomes important.

The MTF is calculated by a Fourier transform of the wave optical intensity distribution at the imaging point. The wave optical intensity distribution is obtained by squaring the wave optical amplitude distribution. That wave optical amplitude distribution is found from a Fourier transform of a pupil function at the exit pupil.

Further, the pupil function is the wavefront information (wavefront aberration) at the exit pupil position, therefore if the wavefront aberration can be strictly calculated as a numerical value through the optical system 210, the MTF can be calculated.

Accordingly, if modifying the wavefront information at the exit pupil position by a predetermined technique, the MTF value on the imaging plane can be freely changed.

In the present embodiment as well, the shape of the wavefront is mainly changed by a wavefront coding optical element. It is truly the phase (length of light path along the rays) that is adjusted to form the desired wavefront.

Then, when forming the target wavefront, the light beams from the exit pupil are formed by a dense ray portion and a sparse ray portion as seen from the geometric optical spot images shown in FIG. 15A to FIG. 15C.

The MTF of this state of light beams exhibits a low value at a position where the spatial frequency is low and somehow maintains the resolution up to the position where the spatial frequency is high.

Namely, if this low MTF value (or, geometric optically, the state of the spot image), the phenomenon of aliasing will not be caused.

That is, a low pass filter is not necessary.

Further, the flare-like image causing a drop in the MTF value may be eliminated by the image processing apparatus 300 configured by the later stage DSP etc. Due to this, the MTF value is remarkably improved.

Next, responses of MTF of the present embodiment and conventional optical system will be considered.

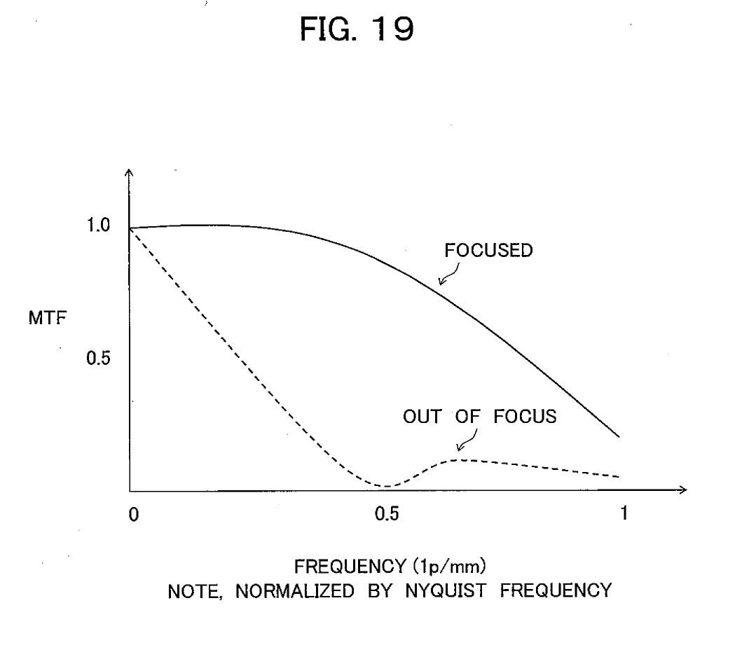

FIG. 19 is a diagram showing the response of the MTF at a time when the object is located at the focal point position and a time when the object deviates from the focal point position in the case of the conventional optical system.

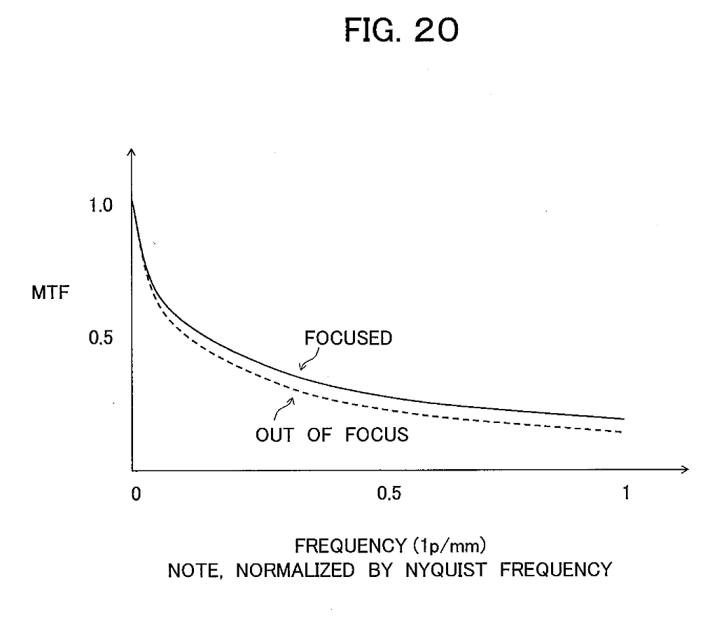

FIG. 20 is a diagram showing the response of the MTF at the time when the object is located at the focal point position and the time when the object deviates from the focal point position in a case of the optical system of the present embodiment having an optical wavefront modulation element.

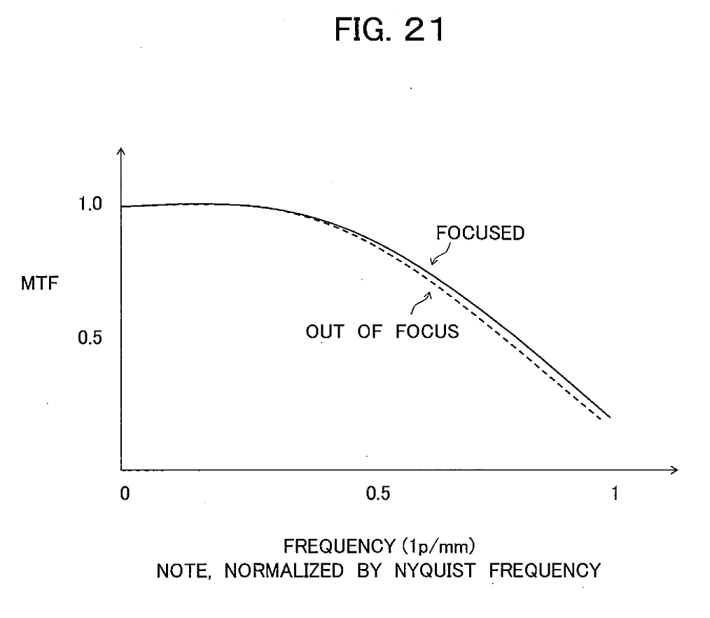

Further, FIG. 21 is a diagram showing the MTF response after data restoration of the image capturing apparatus according to the present embodiment.

As seen from the figures as well, in the case of an optical system having an optical wavefront modulation element, even in a case where the object deviates from the focal point position, a change of the response of the MTF becomes smaller than that of an optical system not having an optical wavefront modulation element inserted.

By processing the image formed by this optical system by the convolution filter, the response of the MTF is improved.

As explained above, according to the present embodiment, since the image capturing apparatus 140 has the imaging lens apparatus 200 for capturing a dispersed image of an object passing through the optical system and the phase plate (optical wavefront modulation element), the image processing apparatus 300 for generating a dispersion-free image signal from a dispersed image signal from the imaging element 220, and the object approximate distance information detection apparatus 400 for generating information corresponding to the distance up to the object, and the image processing apparatus 300 generates a dispersion-free image signal from the dispersed image signal based on the information generated by the object approximate distance information detection apparatus 400, there are the advantages that by making the kernel size used at the time of the convolution operation and the coefficients used in the operation of the numerical values variable, measuring the approximate distance of the object distance, and linking the kernel size having suitability in accordance with the object distance or the above coefficients, the lenses can be designed without regard as to the object distance and defocus range and the image can be restored by high precision convolution.

Further, the image capturing apparatus 140 according to the present embodiment can be used for the wavefront aberration control optical system of a zoom lens designed considering small size, light weight, and cost in a digital camera, camcorder, or other consumer electronic device.

Further, in the present embodiment, since the apparatus has the imaging lens apparatus 200 having the wavefront coding optical element for deforming the wavefront of the image formed on the light receiving surface of the imaging element 220 by the image formation lens 212 and the image processing apparatus 300 for receiving the first order image FIM from the imaging lens apparatus 200 and applying predetermined correction processing etc. to boost the MTF at the spatial frequency of the first order image and form the high definition final image FNLIM, there is the advantage that the acquisition of a high definition image quality becomes possible.

Further, the configuration of the optical system 210 of the imaging lens apparatus 200 can be simplified, production becomes easy, and the cost can be reduced.

When using a CCD or CMOS sensor as the imaging element, there is a resolution limit determined from the pixel pitch. When the resolution of the optical system is over that limit resolution power, the phenomenon of aliasing is generated and exerts an adverse influence upon the final image. This is a known fact.

For the improvement of the image quality, preferably the contrast is raised as much as possible, but this requires a high performance lens system.

However, as explained above, when using a CCD or CMOS sensor as the imaging element, aliasing occurs.

At present, in order to avoid the occurrence of aliasing, the imaging lens apparatus jointly uses a low pass filter made of a uniaxial crystalline system to thereby avoid the phenomenon of aliasing.

The joint usage of the low pass filter in this way is correct in terms of principle, but the low pass filter per se is made of crystal, therefore is expensive and hard to manage. Further, there is the disadvantage that the optical system is more complicated due to the use in the optical system.

As described above, a higher definition image quality is demanded as a trend of the times. In order to form a high definition image, the optical system in a general imaging lens apparatus must be made more complicated. If it is complicated, production becomes difficult. Also, the utilization of the expensive low pass filters leads to an increase in the cost.

However, according to the present embodiment, the occurrence of the phenomenon of aliasing can be avoided without using a low pass filter, and it becomes possible to obtain a high definition image quality.

Note that, in the present embodiment, the example of arranging the wavefront coding optical element of the optical system 210 on the object side from the stop was shown, but functional effects the same as those described above can be obtained even by arranging the wavefront coding optical element at a position the same as the position of the stop or on the image formation lens side from the stop.

Further, the lenses configuring the optical system 210 are not limited to the example of FIG. 7. In the present invention, various aspects are possible.

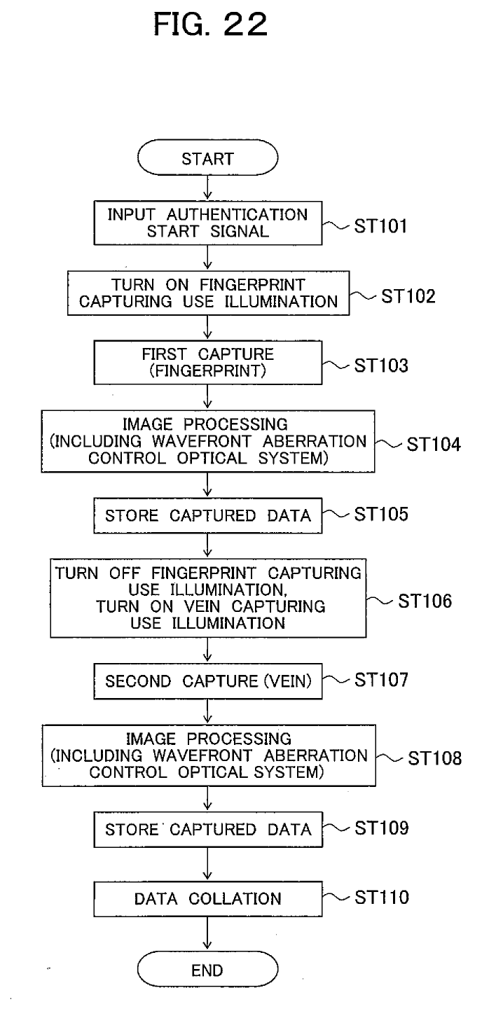

Next, an explanation will be given of the operation of the biometric authentication apparatus of the present embodiment with reference to the flow chart of FIG. 22.

When the control system receives as input an authentication start signal (ST101), the fingerprint capturing use illumination apparatus 120 is turned on (ST102).

Then, the image capturing apparatus 140 performs the capture of the fingerprint as the first operation (ST103).

The image capturing apparatus 140 performs the image processing in the image processing apparatus 300 etc. including the wavefront aberration control optical system (ST104) and stores the captured data (ST105).

Next, the fingerprint capturing use illumination apparatus 120 is turned off, and the vein capturing use illumination apparatus 130 is turned on (ST106).

Then, the image capturing apparatus 140 performs the capture of the vein as the second operation (ST107).

The image capturing apparatus 140 performs the image processing in the image processing apparatus 300 etc. including the wavefront aberration control optical system (ST108) and stores the captured data (ST109).

Then, the collation based on the stored fingerprint data and vein data is carried out (ST110).

As described above, the biometric authentication apparatus 100 of the present embodiment has the transparent plate 110 formed by for example glass or plastic for placement of the finger of the authenticated person, that is, the inspected specimen OBJ, downward in the figure (surface where fingerprint is located facing downward), the fingerprint capturing use illumination apparatus 120, the vein capturing use illumination apparatus 130, and the image capturing apparatus 140 as principal components, and the image capturing apparatus 140 is provided with the field depth enlarging optical system having the optical wavefront modulation element and the image processing unit, so the following effects can be obtained.

Namely, a biometric authentication apparatus having a simple configuration, able to easily focus on a fingerprint or vein or other blood vessel patterns and able to clearly capture an image, able to prevent forgery, and in addition able to realize high precision authentication can be realized.

More specifically, it becomes unnecessary to make the stop small, that is, dark, in order to obtain the field depth as in the usual optical system, therefore the required light amount may be reduced in comparison with that in the usual optical system. Due to this, the amount of light of the illumination apparatus can be reduced.

Accordingly, a reduction of cost of the illumination apparatus and a reduction of the power consumption become possible and, as a result, the durability of the illumination apparatus can be improved.

On the other hand, even when the location for placing the inspected specimen is not a constant point, a focused image can be obtained, therefore authentication without touching the apparatus becomes possible although a certain degree of range must be set.

Further, in the biometric authentication apparatus 100 of the first embodiment, the priority order of the plurality of authentication results can be switched in accordance with the situation, the authentication rate can be improved by a single authentication operation, and high precision authentication becomes possible without lowering the authentication rate due to a plurality of authentication operations.

Further, in the present first embodiment, an explanation was given of authentication using a fingerprint and vein pattern, but the present invention can be applied even to other combinations, for example, the iris and eyeground.

Next, as a second embodiment of the present invention, an explanation will be given of a biometric authentication apparatus which can perform an iris authentication operation in addition to the fingerprint authentication operation and/or vein authentication operation and can perform authentications of a different plurality of portions.

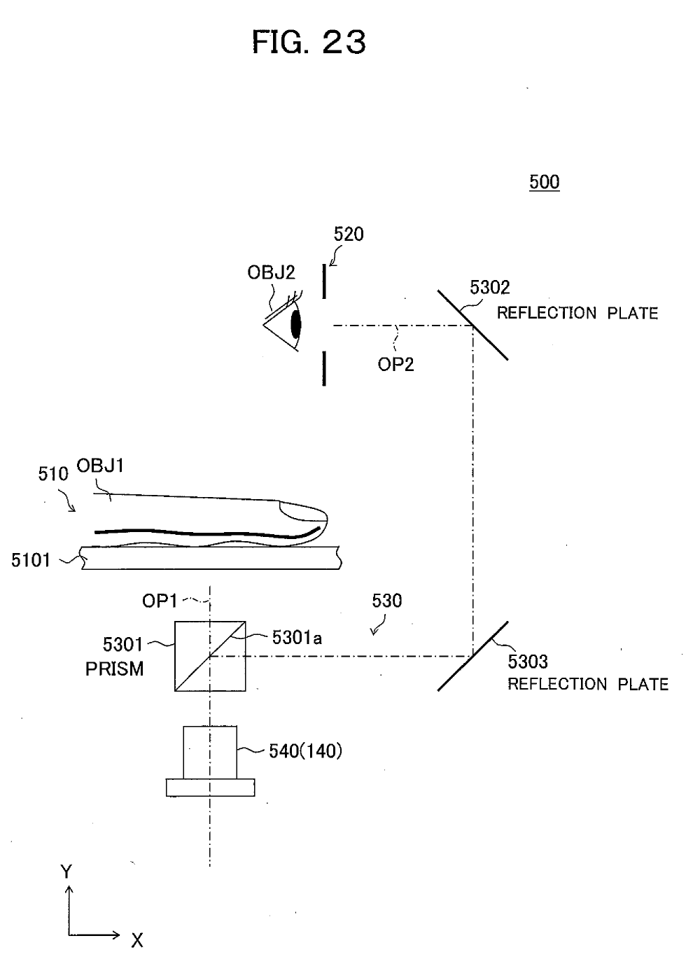

FIG. 23 is a diagram schematically showing an example of the configuration of a biometric authentication apparatus according to the second embodiment of the present invention.

A biometric authentication apparatus 500 of FIG. 23 is configured as an apparatus able to perform authentication operations of a different plurality of portions including a fingerprint authentication operation and/or vein authentication operation and iris authentication operation.

The present biometric authentication apparatus 500, as shown in FIG. 23, has a first information acquisition unit 510 having transparent plate 5101 formed by for example glass or plastic for placement of a finger of the authenticated person, that is, the inspected specimen OBJ1, downward in the figure (surface where fingerprint is located facing downward) and illumination apparatuses and acquiring fingerprint and/or vein information, a second information acquisition unit 520 for acquiring the iris information from the eye of the authenticated person, that is, the inspected specimen OBJ2, an information light use light path formation unit 530, and an image capturing apparatus 540 as principal components.

When the present biometric authentication apparatus 500 is used, the authenticated person places the inspected specimen OBJ1, that is, his or her finger, on the transparent plate 5101 of the first information acquisition unit 510 in a downward direction in the figure (the fingerprint surface facing downward) and makes the inspected specimen OBJ2, that is, his or her eye, look at (peep into) the information light use light path formation unit 530 side (right side in FIG. 23) from the second information acquisition unit 520.

In this way, the biometric authentication apparatus 500 of FIG. 23 is configured as an apparatus able to perform authentication operations of a different plurality of portions of the fingerprint authentication operation and/or vein authentication operation and iris authentication operation.

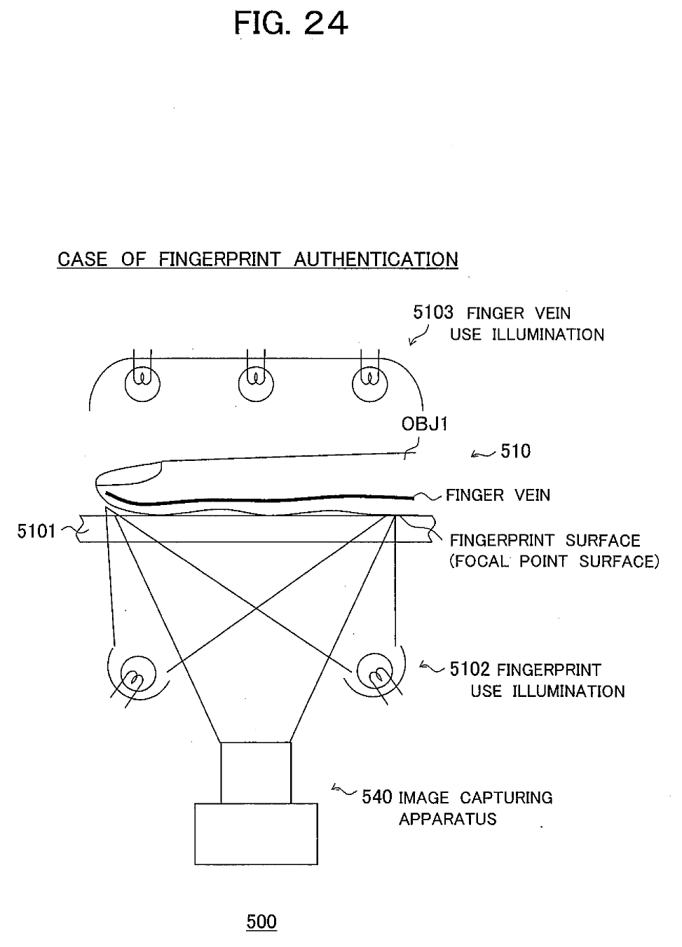

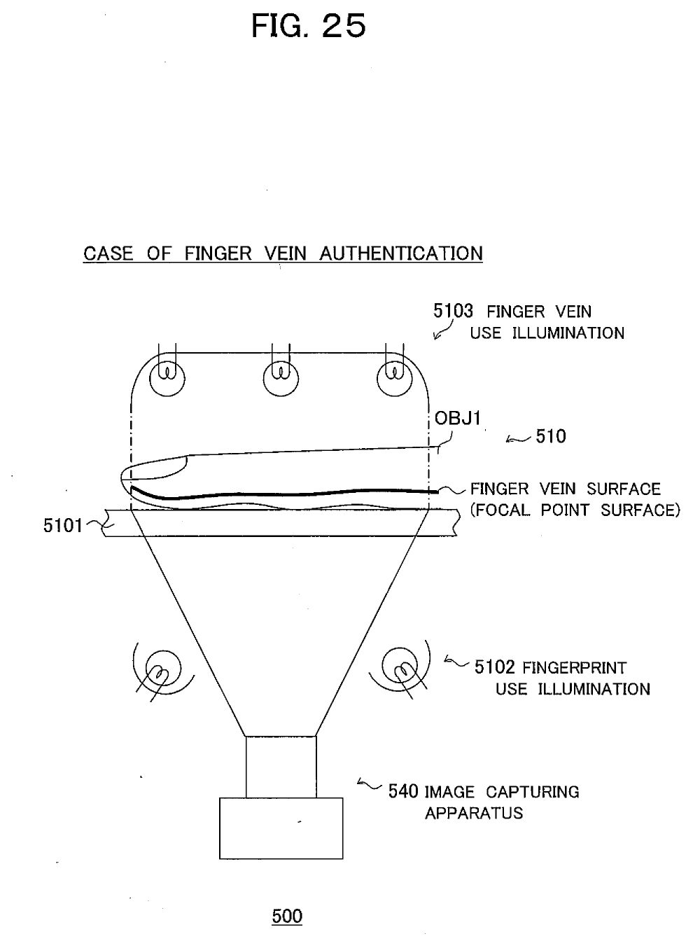

Further, FIG. 24 is a diagram schematically showing the fingerprint authentication operation in the biometric authentication apparatus of FIG. 23, and FIG. 25 is a diagram schematically showing the vein authentication operation in the biometric authentication apparatus of FIG. 23.

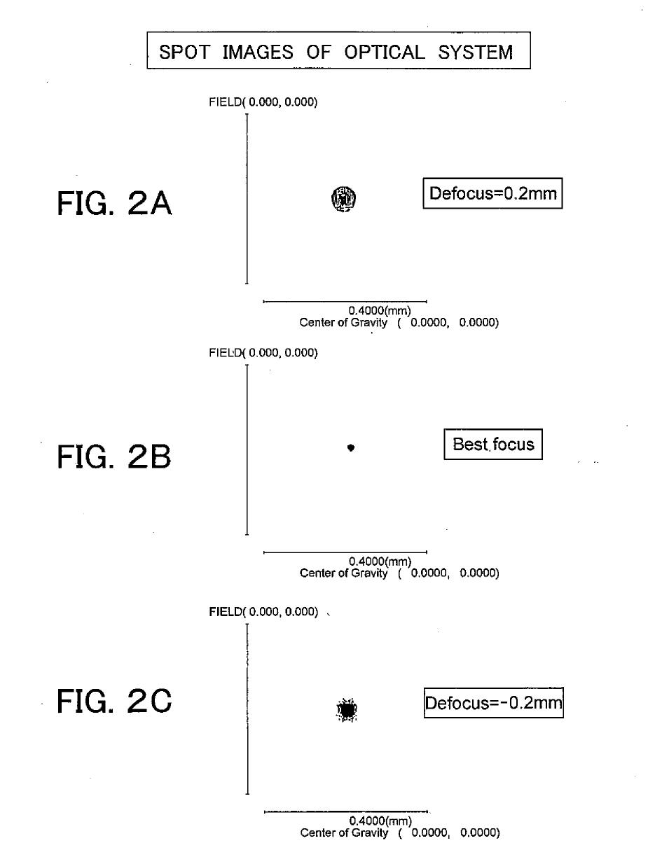

The fingerprint authentication operation and vein authentication operation of the biometric authentication apparatus 500 in the second embodiment are carried out in the same way as the biometric authentication operation and vein authentication operation in the first embodiment explained with reference to FIG. 2 and FIG. 3.

Namely, in the biometric authentication apparatus 500, as shown in FIG. 24, the image capturing apparatus 540 is arranged on the side of the front surface of the inspected specimen OBJ1 (surface where palm print is located), and the illumination apparatus 5102 is arranged on the same side for the purpose of assisting the capture of the fingerprint.

Further, as shown in FIG. 25, the illumination apparatus 5103 is arranged on the side of the back surface of the inspected object OBJ (surface where fingernails are located) for the purpose of assisting the capture of the veins.

The illumination apparatuses are not referred to in detail here, but preferably, as the fingerprint capturing use illumination apparatus 5102, use is made of visible light or a light source having a wavelength suitable for further highlighting the fingerprint, and as the vein capturing use illumination apparatus 5103, use is made of a light source suitable for passing through the skin and highlighting the blood vessels, for example, a light source emitting infrared rays.

Note that, although not shown, for the second information acquisition unit 520 for acquiring the iris information as well, a configuration arranging a predetermined illumination light source can be employed.

The information light use light path formation unit 530 has a prism 5301 as the information introduction unit for making first information light OP1 including the fingerprint or vein information and second information light OP2 including the iris information strike the image capturing apparatus 540 and reflection plates (reflection mirrors) 5302 and 5303 for forming a light guide path of the second information light OP2 including the iris information to the prism 5301.

The prism 5301 serving as the information introduction unit has a transmission/reflection face 5301a thereof arranged at the middle of the light path of the first information light OP1 between the first information acquisition unit 510 and the image capturing apparatus 540.

In the present embodiment, the prism 5301 transmits the first information light OP1 including the fingerprint or vein information acquired at the first information acquisition unit 510 therethrough as it is and makes this strikes (introduces this into) the image capturing apparatus 540.

Further, the prism 5301 reflects the second information light including the iris information reflected at the reflection plate 5303 at the transmission/reflection face 5301a and makes this strike (introduces this into) the image capturing apparatus 540.

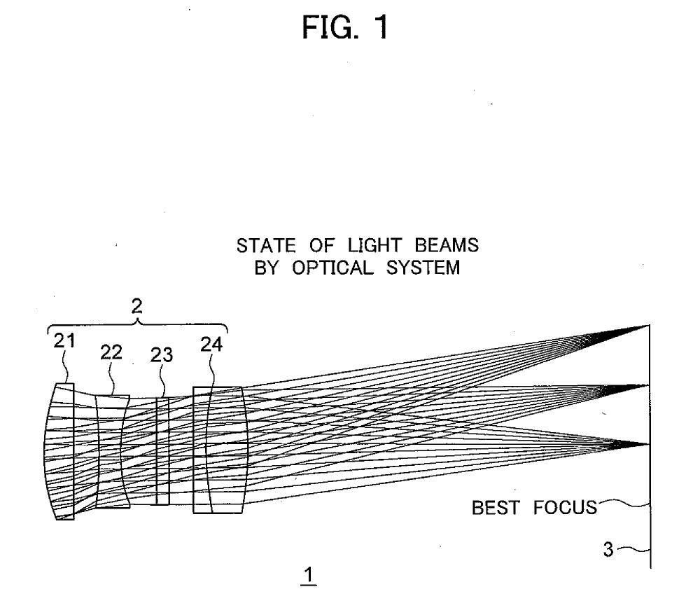

The reflection plate 5302 reflects the second information light OP2 including the iris information emitted to the right side in the figure (X direction in an orthogonal coordinate system set in FIG. 1) by the second information acquisition unit 520, changes the light path of the second information light OP2 by approximately 90 degrees, and emits this in a downward direction in the figure (Y direction).

The reflection plate 5303 reflects the second information light OP2 including the iris information reflected at the reflection plate 5302, changes the light path of the second information light OP2 by approximately 90 degrees toward the leftward direction in the figure (X direction), and makes it strike the transmission/reflection face 5301a of the prism 5301.

Note that, in the present embodiment, an explanation was given of the case where the light path was changed twice by approximately 90 degrees, but the present invention is not limited to this.

The image capturing apparatus 540 has a field depth enlarging optical system having an optical wavefront modulation element and an image processing unit and is configured so that a restored image can be output.

The image capturing apparatus 540 includes a storage unit for temporarily storing the image data, a data conversion unit for comparing and collating the image data, a storage unit of data registered in the other, a processing unit for performing the comparison and collation, and further an instruction unit for issuing an instruction in accordance with the results of the comparison and collation.

Note that here the explanation is given taking as an example a case where the apparatus is shown alone, but a configuration for handling a network utilizing a dedicated line, Internet, etc. is possible as well. In that case, the system configuration becomes one having a server where the registered data becomes the host of the network.

By employing the image capturing apparatus 540 provided with the field depth enlarging optical system having the optical wavefront modulation element and the image processing unit as in the present embodiment, it is possible to obtain the following characteristic features.

In the usual optical system, it becomes necessary to make the stop small, that is, dark, in order to obtain the field depth.

Contrary to this, in the “depth enlarging optical system” of the present embodiment explained in detail later, it becomes unnecessary to make the stop small, therefore the required light amount may be reduced in comparison with the usual optical system. Accordingly, the amount of light of the illumination apparatus can be reduced.

This makes it possible to reduce the cost of the illumination apparatus and reduce the power consumption. As a result, the durability of the illumination apparatus can be improved.

On the other hand, a focused image can be obtained even when the location where the inspected specimen is placed is not a constant point, therefore authentication without touching an apparatus becomes possible although a certain range must be set.

In this way, the image capturing apparatus 540 has the same configuration as that of the image capturing apparatus 140 explained with reference to FIG. 6 to FIG. 21 in the first embodiment explained above, has the field depth enlarging optical system having the optical wavefront modulation element and the image processing unit, and is configured so that a restored image can be output.

Accordingly, a concrete explanation of the configuration and function of the image capturing apparatus 540 is omitted here.

Note that, in the explanation concerning the configuration and function of the image capturing apparatus 540, notations employed in FIG. 6 to FIG. 21 are used according to need.

Further, in the biometric authentication apparatus 500 of the present embodiment, the priority order of the plurality of authentication results can be switched in accordance with the situation.

As the switching method of the priority order of the authentication and collation, for example a method of collating the captured data with the registered data and switching the priority order based on that collation result can be employed. Further, as another method, a method where the user (subject) makes the selection when performing the authentication can be employed as well.

In the present embodiment, in for example a case where the authentication precision of a fingerprint becomes low due to injury, dirt, or the like, the vein authentication is given a higher priority.

Conversely, it is possible to employ a method giving a higher priority to the fingerprint authentication in a state where the temperature of the inspected specimen greatly changes, for example a case where the subject becomes cold and in that case his or her flow of blood becomes bad or a case where the authentication precision becomes low due to an injury etc.

Note that, here, the switching of the priority order means adjustment by weighting each authentication in advance and is different from employing just one authentication result.

Due to this, the authentication rate can be improved over one authentication operation, and authentication having a high precision becomes possible without lowering the authentication rate due to the plurality of authentication operations.

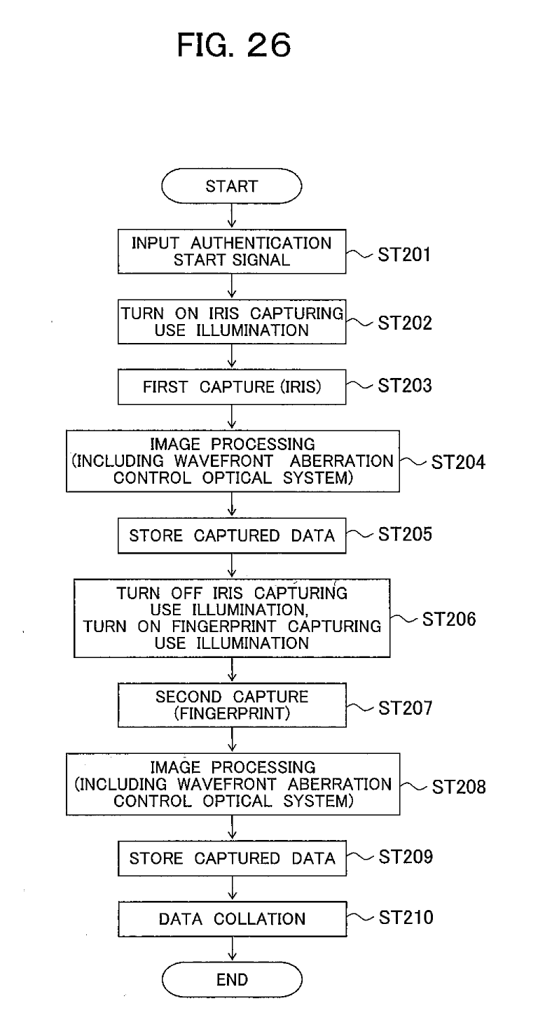

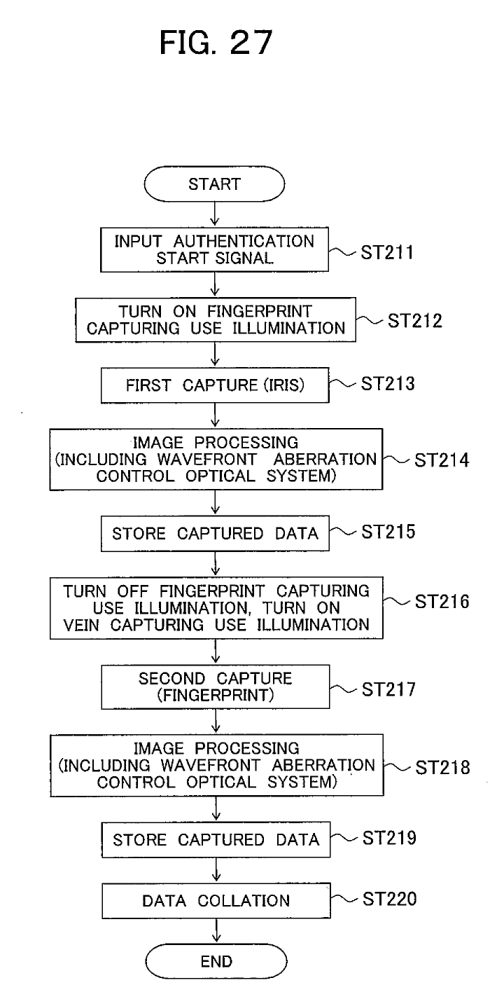

Next, an explanation will be given of the authentication operation of a different plurality of portions of the biometric authentication apparatus of the second embodiment with reference to the flow charts of FIG. 26 and FIG. 27.

FIG. 26 is a flow chart for explaining the authentication operations of the iris and fingerprint of the biometric authentication apparatus of the second embodiment.

FIG. 27 is a flow chart for explaining the authentication operations of the fingerprint and vein of the biometric authentication apparatus of the second embodiment.

First, an explanation will be given of the authentication operations of the iris and fingerprint with reference to FIG. 26.

When the control system receives as input the authentication start signal (ST201), a not shown iris capturing use illumination apparatus is turned on (ST202).

Then, the image capturing apparatus 540 captures the iris as the first operation (ST203).

In this case, the second information light OP2 including the iris information strikes the prism 5301 via the reflection plates 5302 and 5303, is reflected at the transmission/reflection face 5301a, and strikes the image capturing apparatus 540.

The image capturing apparatus 540 performs the image processing in the image processing apparatus 300 etc. including the wavefront aberration control optical system (ST204) and stores the captured data (ST205).

Next, the iris information capturing use illumination apparatus is turned off, and the fingerprint capturing use illumination apparatus 5102 is turned on (ST206).

Then, the image capturing apparatus 540 captures the fingerprint as the second operation (ST207).

In this case, the first information light OP1 including the fingerprint information strikes the prism 5301, passes through the transmission/reflection face 5301a, and strikes the image capturing apparatus 540.

The image capturing apparatus 540 performs the image processing in the image processing apparatus 300 etc. including the wavefront aberration control optical system (ST208) and stores the captured data (ST209).

Then, the collation based on the stored iris data and fingerprint data is carried out (ST210).

Next, an explanation will be given of the authentication operations of the fingerprint and vein with reference to FIG. 27. The authentication operations of the fingerprint and vein in the second embodiment are carried out in the same way as the authentication operations of the fingerprint and vein of the first embodiment explained with reference to FIG. 22.

When the control system receives as input the authentication start signal (ST211), the fingerprint capturing use illumination apparatus 5102 is turned on (ST212).

Then, the image capturing apparatus 540 captures the fingerprint as the first operation (ST213).

In this case, the first information light OP1 including the fingerprint information strikes the prism 5301, passes through the transmission/reflection face 5301a, and strikes the image capturing apparatus 540.

The image capturing apparatus 540 performs the image processing in the image processing apparatus 300 etc. including the wavefront aberration control optical system (ST214) and stores the captured data (ST215).

Next, the fingerprint information capturing use illumination apparatus 5102 is turned off, and the vein capturing use illumination apparatus 5103 is turned on (ST216).

Then, the image capturing apparatus 540 captures the vein as the second operation (ST217).

In this case, the first information light OP1 including the vein information strikes the prism 5301, passes through the transmission/reflection face 5301a, and strikes the image capturing apparatus 540.

The image capturing apparatus 540 performs the image processing in the image processing apparatus 300 etc. including the wavefront aberration control optical system (ST218) and stores the captured data (ST219).

Then, the collation based on the stored fingerprint data and vein data is carried out (ST220).

Note that the authentication operations of the iris and vein are carried out in the same way.

As described above, the biometric authentication apparatus 500 of the second embodiment has the first information acquisition unit having the transparent plate 5101 formed by for example glass or plastic for placement of the finger of the authenticated person, that is, the inspected specimen OBJ1, downward in the figure (surface where fingerprint is located facing downward) and illumination apparatuses and acquiring fingerprint and vein information, the second information acquisition unit 520 for acquiring the iris information from the eye of the authenticated person, that is, the inspected specimen OBJ2, the information light use light path formation unit 530, and the image capturing apparatus 540, and the image capturing apparatus 540 is provided with the field depth enlarging optical system having the optical wavefront modulation element and the image processing unit, so can obtain the following effects.

Namely, a biometric authentication apparatus having a simple configuration, able to easily focus on a plurality of biometric information and able to clearly capture the image, able to simultaneously perform a plurality of authentication operations such as iris authentication, fingerprint authentication, and vein authentication, etc. and in addition able to realize high precision authentication and able to reduce the erroneous authentication rate can be realized.

More specifically, it becomes unnecessary to make the stop small, that is, dark, in order to obtain the field depth as in the usual optical system, therefore the required light amount may be reduced in comparison with that in the usual optical system. Due to this, the amount of light of the illumination apparatus can be reduced.

Accordingly, a reduction of cost of the illumination apparatus and a reduction of the power consumption become possible and, as a result, the durability of the illumination apparatus can be improved.

On the other hand, even when the location for placing the inspected specimen is not a constant point, a focused image can be obtained, therefore authentication without touching the apparatus becomes possible although a certain degree of range must be set.

Further, in the biometric authentication apparatus 500 of the second embodiment, the priority order of the plurality of authentication results can be switched in accordance with the situation, the authentication rate can be improved by a single authentication operation, and high precision authentication becomes possible without lowering the authentication rate due to a plurality of authentication operations.

Further, in the present embodiment, the explanation was given of authentication using the iris and fingerprint or vein pattern, but the present invention can also be applied to other combinations, for example, the iris and eyeground.

Note that the configuration of the light path formation unit 530 is not limited to the configuration of FIG. 23. Various aspects are possible.

Below, an explanation will be given of other examples of configurations of the light formation unit and optical system.

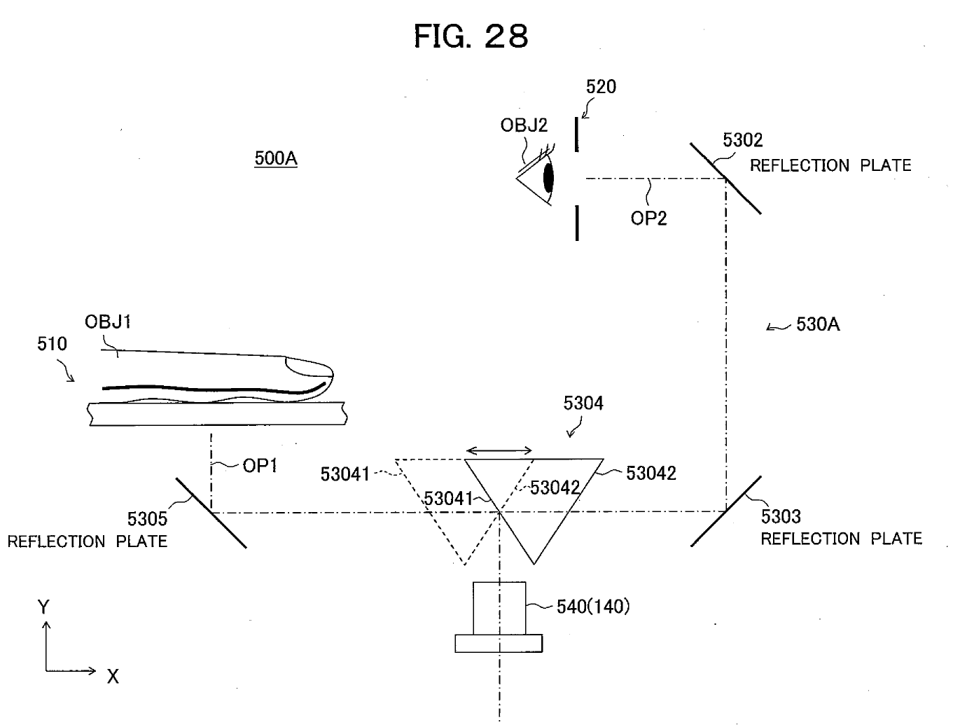

FIG. 28 is a diagram schematically showing a biometric authentication apparatus according to a third embodiment of the present invention.

The difference of a biometric authentication apparatus 500A of FIG. 28 from the biometric authentication apparatus 500 of FIG. 23 resides in that a reflection plate (face) group 5304 able to move in the X direction of the orthogonal coordinate system set in the figure is provided in place of forming the information introduction unit for introducing two information lights OP1 and OP2 into the image capturing apparatus 540 (140) by a prism in a light path formation unit 530A.

Further, the light path formation unit 530A of FIG. 28 is provided with a reflection plate 5305 for reflecting the first information light OP1 including the fingerprint or vein information from the first information acquisition unit 510.

Then, the reflection plate group 5304 is arranged on a reflection light path of the first information light OP1 from the reflection plate 5305 and a reflection light path of the second information light OP2 from the reflection plate 5303. Along with this, the image capturing apparatus 540 is arranged in the vicinity of the reflection plate group 5304 as well.

The reflection plate group 5304 has two reflection plates 53041 and 53042.

The reflection plate group 5304 is controlled so that, when introducing the first information light OP1 into the image capturing apparatus 540, it moves to a first state indicated by a solid line in FIG. 28, reflects the first information light OP1 at the reflection plate 53041, and introduces this into the image capturing apparatus 540.

On the other hand, when introducing the second information light OP2 into the image capturing apparatus 540, it is controlled so as to move to a state indicated by a broken line in FIG. 28 (moves in the leftward X direction in the figure from the first state), reflect the second information light OP2 at the reflection plate 53042, and introduce this into the image capturing apparatus 540.

In the third embodiment as well, the same effects as those by the second embodiment explained above can be obtained.

In the above explanation, the light path formation unit and the optical system of the image capturing apparatus 540 were explained as different configurations. However, for example as shown in FIG. 23, an optical system 210A of an image capturing apparatus 540A is configured as follows.

The optical system 210A can be configured so as to provide a prism 5301 in a light path between an object side lens 211 as the first lens and an optical wavefront modulation element group 213 including a lens as the second lens and optical wavefront modulation element and so as to provide a wide angle optical system WD for the first information light OP1 and a telephoto optical system TEL for the second information light OP2.

Further, an object side lens 214 of the telephoto optical system is arranged in a light path reaching a transmission/reflection face 5301a of the prism 5301 of the second information light OP2.

In this example, optical parts from the prism 5301 to the imaging element 220 are shared by the wide angle optical system and the telephoto optical system.

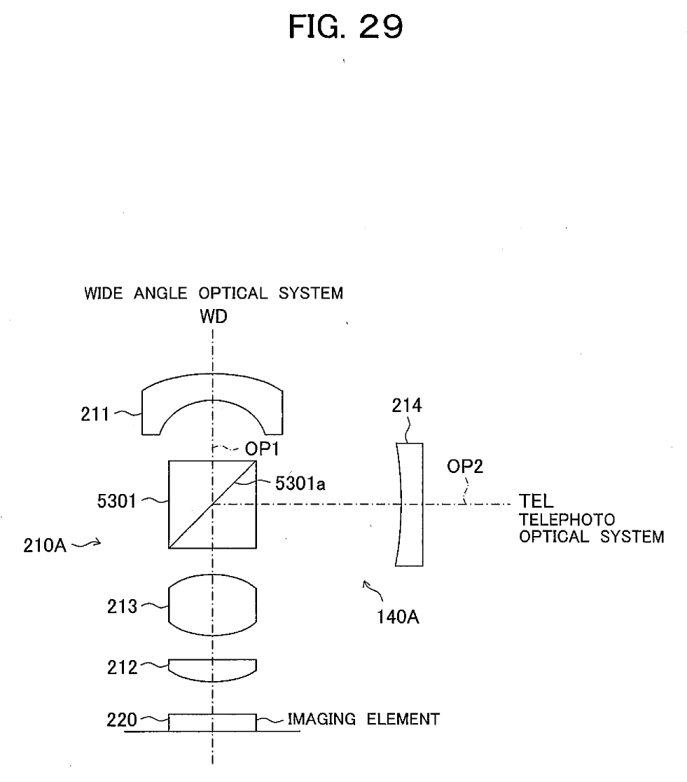

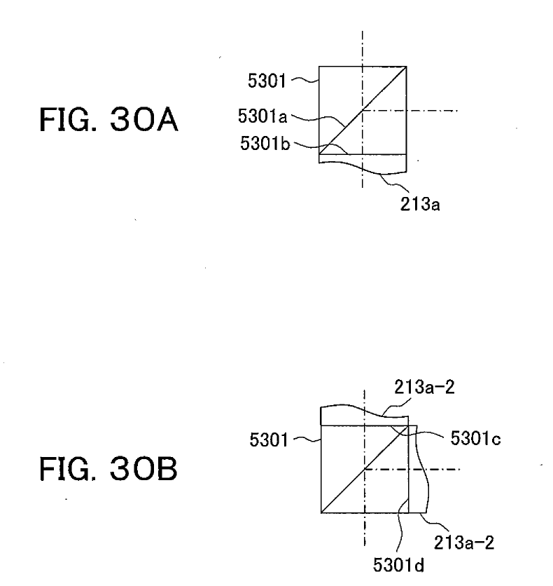

In this case, the optical wavefront modulation element 213, as shown in FIG. 30A of an enlarged diagram of the prism 5301 of FIG. 29, can employ a configuration arranging this on a light emission face 5301b of the prism 5301 or can employ a configuration arranging this on an incident face 5301c of the first information light OP1 and an incident face 5301d of the second information light OP2 as shown in FIG. 30B.

In the case of the configuration of FIG. 30B, two optical wavefront modulation elements 213a-1 and 231a-2 are preferably formed into phase modulation faces suitable for optical systems. Due to this, it becomes possible to obtain better images.

Note that, in examples of FIG. 30A and FIG. 30B, an explanation was given of a case where the optical wavefront modulation element was provided at the prism 5301, but this may be provided at both of the first information light OP1 and second information light OP2 or between the prism 5301 and the imaging element 220.

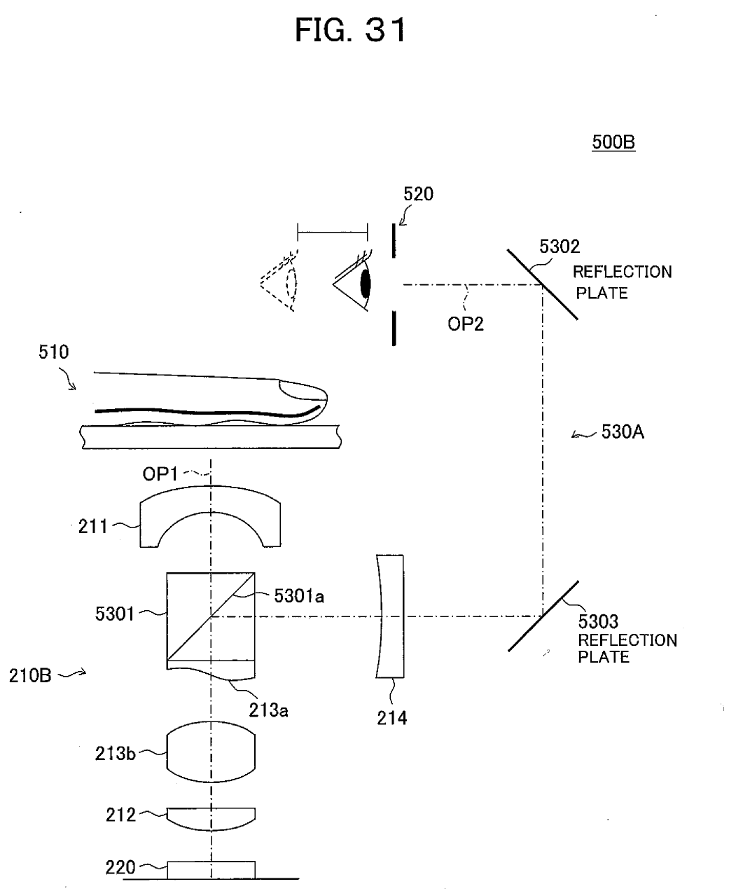

FIG. 31 is a diagram schematically showing a biometric authentication apparatus according to a fourth embodiment of the present invention.

A biometric authentication apparatus 500B according to the fourth embodiment is formed by combining the configurations of FIG. 29 and FIG. 30A.

Note that in the optical system 210B of FIG. 31, the optical wavefront modulation element 213a of the optical wavefront modulation element group 213 of FIG. 29 is arranged at the prism 5301, and only the lens is arranged as the second lens group 213b between the optical wavefront modulation element 213a and the image formation lens 212.

Due to this, with a simple configuration, fingerprint authentication and vein authentication and further iris information can be realized by one authentication apparatus.

Further, the field depth enlarging optical system is used, therefore flexibility can be imparted to the location (distance) at for example the iris authentication.

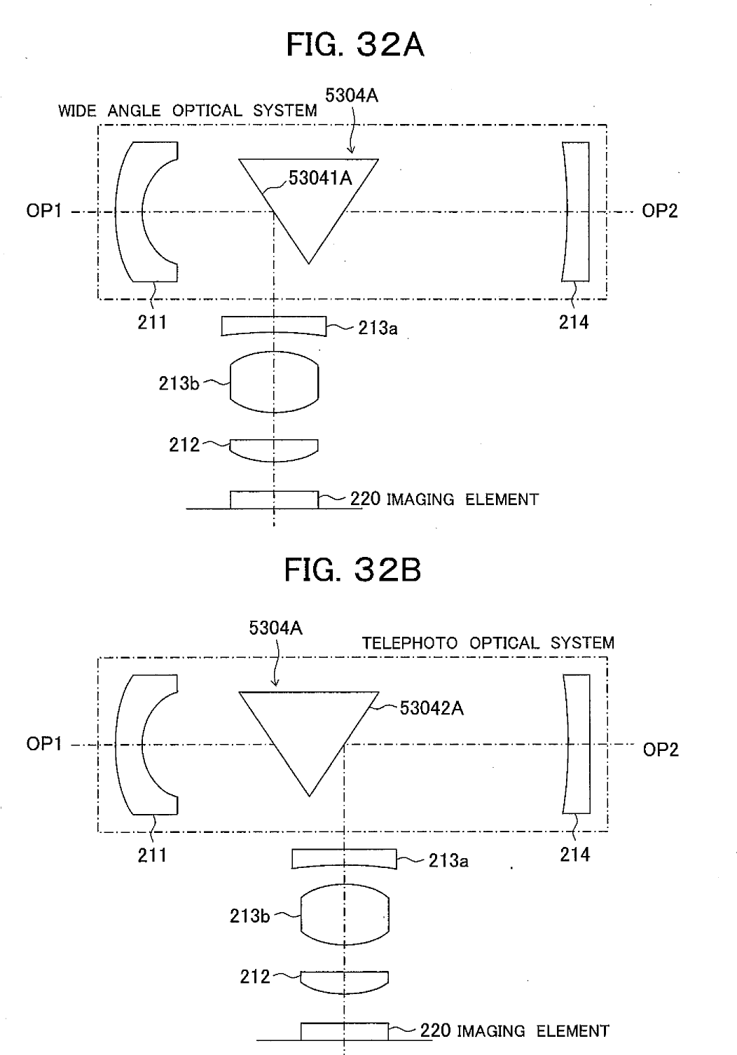

Note that a diagram showing a configuration where a reflection plate group 5304A is provided in the same way as FIG. 28 in place of the use of the prism and two optical systems are switched is given in FIG. 32.

FIG. 32A shows a wide angle optical system state, and FIG. 32B shows a telephoto optical system state. Further, optical parts between the reflection plate (face) group 5304A and the imaging element 220 are shared.

The reflection plate group 5304A is controlled so that, when introducing the first information light OP1 into the imaging element 220, it moves to the first state shown in FIG. 32A, reflects the first information light OP1 at a reflection plate 53041A, and introduces this into the imaging element 220.

On the other hand, when introducing the second information light OP2 into the imaging element 220, it is controlled so as to move to a state shown in FIG. 32B (moves in the leftward X direction in the figure from the first state), reflect the second information light OP2 at a reflection plate 53042A, and introduce this into the imaging element 220.

Note that, the configuration of the optical system in the light path reaching the imaging element 220 from each reflection face of the reflection plate group 5304A is the same as that of FIG. 31.

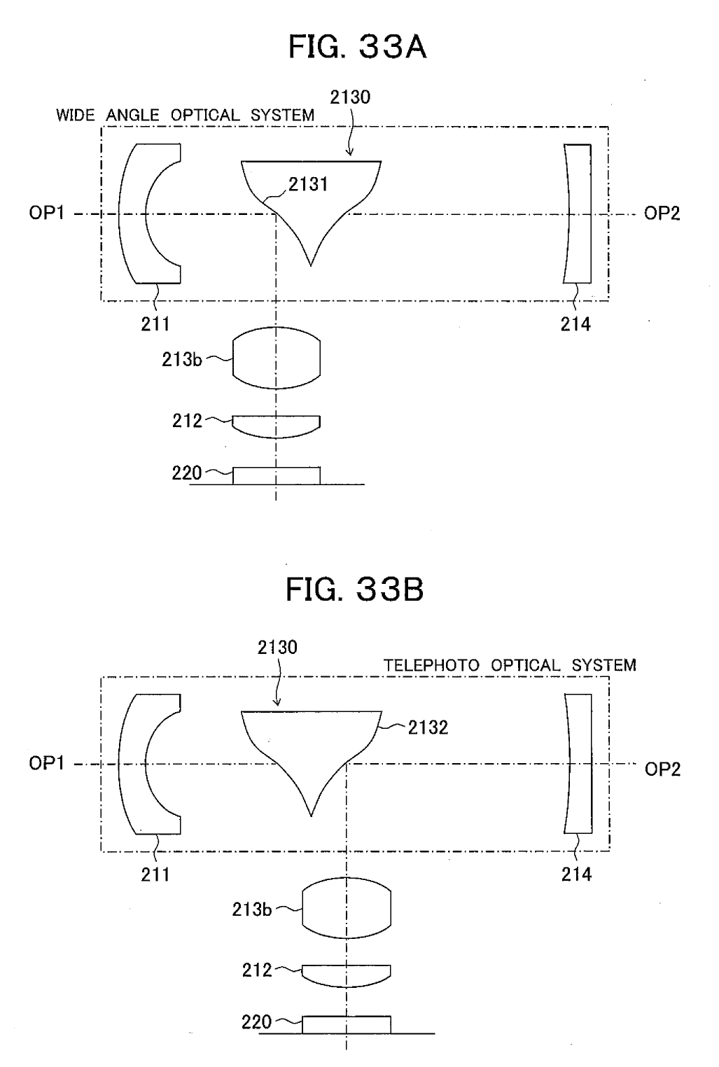

Further, as shown in FIG. 33A and FIG. 33B, a reflection type optical wavefront modulation element plate (face) 2130 can be provided in place of the reflection plate group.

In this case, the optical wavefront modulation plate group 2130 is configured by forming optical wavefront modulation elements 2131 and 2132 at arrangement positions of two reflection plates of the reflection plate group 5304A of FIG. 32A and FIG. 32B.

The optical wavefront modulation plate group 2130 is controlled so that, when introducing the first information light OP1 into the imaging element 220, it moves to the first state shown in FIG. 33A, reflects the first information light OP1 at the optical wavefront modulation plate 2131, and introduces this into the imaging element 220.

On the other hand, when introducing the second information light OP2 into the imaging element 220, it is controlled so as to move to a state shown in FIG. 33B (moves in the leftward X direction in the figure from the first state), reflect the second information light OP2 at the optical wavefront modulation plate 2132, and introduce this into the imaging element 220.

Note that, two optical wavefront modulation plates are preferably formed into phase modulation faces suitable for optical systems, that is, a wide angle optical system and telephoto optical system.

Alternatively, a configuration arranging optical wavefront modulation elements in both light paths of the first information light OP1 and second information light OP2 can be employed as well.

As explained above, according to the present embodiment, it is possible to extend the field depth in each authentication even by the use of field depth enlarging optical systems for optical systems of for example image capturing apparatuses shown in FIG. 23 and FIG. 28.

Further, however, as in FIG. 29 to FIGS. 33A and 33B, when providing them inside the optical system forming two optical systems of for example a wide angle optical system and telephoto optical system, even a case of different authentication formats can be easily handled. For example, since the sizes and distances of objects are almost the same in the fingerprint authentication and vein reference, therefore is no problem in an optical system of one image angle.

However, in for example the iris authentication, the size, distance, etc. of the object differ. However, if providing an apparatus and optical system for each authentication content, there are problems of cost, space, etc. Further, the authentication results become different. However, according to this embodiment, it becomes possible to comprehensively judge all authentication results, and the authentication precision can be improved more.

Further, by employing a variable magnification depth enlarging optical system, even in a case where the distance of the object greatly changes, it becomes possible to perform the authentication without lowering the resolution by magnifying the size of the object up to the predetermined size.

The image capturing apparatuses 140 and 540 employed in embodiments explained above are provided with zoom optical systems as explained above and can adjust sizes of objects (inspected specimens) OBJ input to the imaging elements 220 to constant sizes by these zoom optical systems.

Below, as fifth, sixth, and seventh embodiments, an explanation will be given of the adjustment function of the size of the object fetched into the imaging element.

First, as the fifth embodiment, an explanation will be given of a basic adjustment function of an image capturing apparatus having a field depth enlarging optical system having an optical wavefront modulation element and an image processing unit and configured so that the restored image can be output.

Note that, here, the explanation is given predicated on the biometric authentication apparatus 100 of FIG. 3 for performing the authentication of the fingerprint and vein as in the first embodiment. Further, the zoom optical system has the same configuration as that of the zoom optical system shown in FIG. 7.

Further, the image capturing apparatus has the same configuration as that of the image capturing apparatus 140 explained with reference to FIG. 6 to FIG. 21 in the first embodiment explained above, has a field depth enlarging optical system having an optical wavefront modulation element and an image processing unit, and is configured so that the restored image can be output.

Accordingly, in the following explanation concerning the configurations and functions of the image capturing apparatus and zoom optical system, use will be made of notations employed in FIG. 6 to FIG. 21.

In the present embodiment, by employing the zoom optical system 210 (FIG. 7), even when the size of the object (inspected specimen) changes, it can be handled, the resolution of the captured image according to the location of the object is kept, and the authentication precision is improved.

Namely, the image capturing apparatus 140 of the present embodiment can adjust the size of the object input to the imaging element 220 to a constant size by the zoom optical system 210.

Further, the zoom optical system 210 is controlled so as to become the operating state when the fingerprint, vein, or other authenticated object changes.

In the present embodiment, by providing the zoom optical system 210, it becomes possible to adjust for example the size of the hand input to the imaging element 220 to a certain specific size.

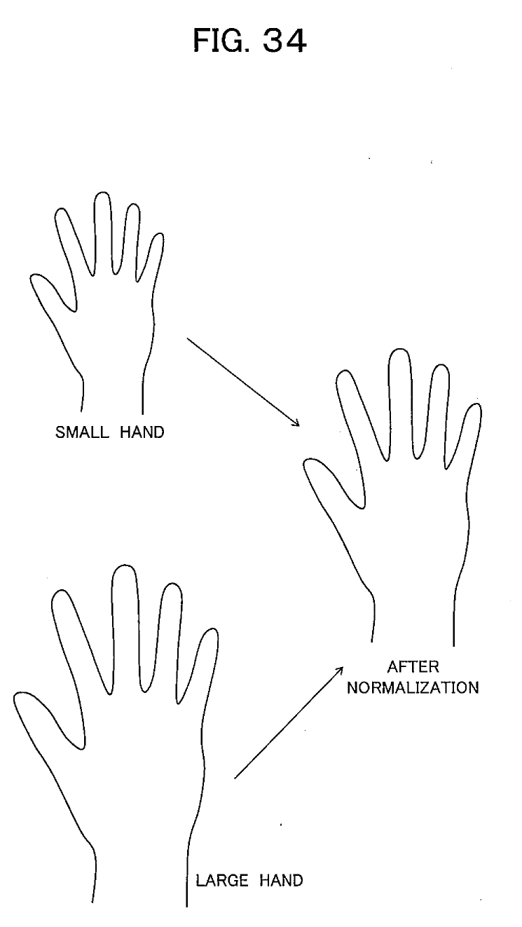

FIG. 34 is a schematic diagram showing that the size of the hand is adjusted to a certain specific size.

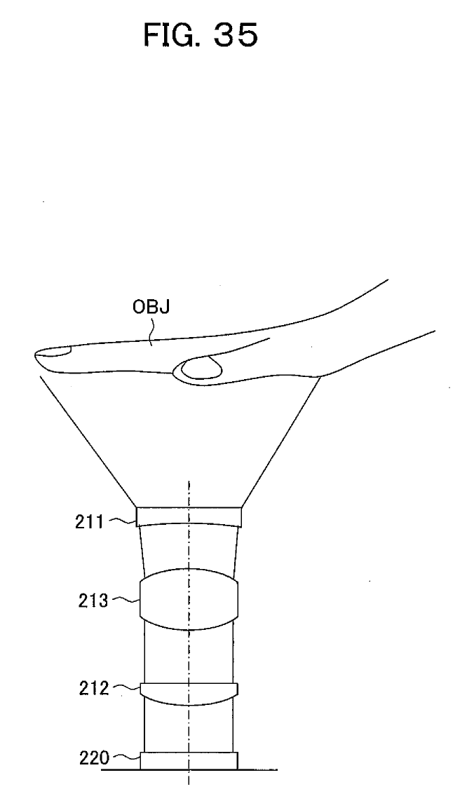

Below, an explanation will be given of the adjustment function according to the fifth embodiment with reference to FIG. 35 to FIG. 39.

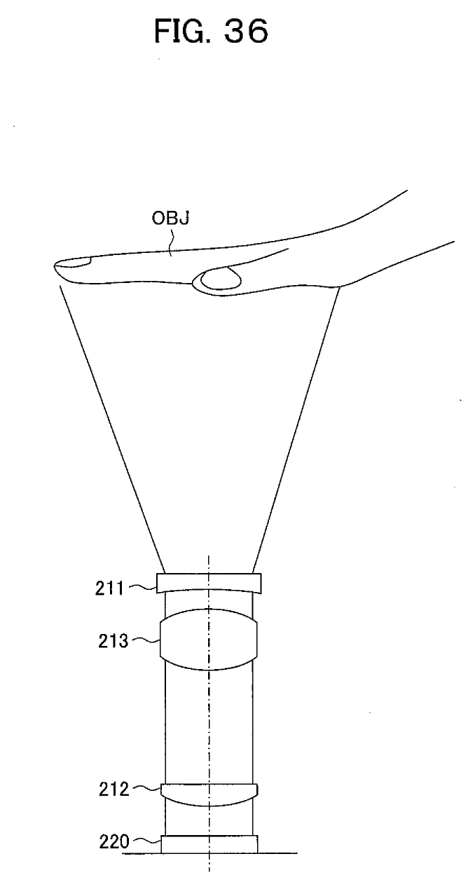

Further, FIG. 35 and FIG. 36 are diagrams showing states where the size of a captured hand is made the same by changing the magnification by moving the optical system according to the location where the finger of the hand serving as the object OBJ is held aloft.

In this way, in the present embodiment, since a zoom optical system is employed, the state where the size of the captured hand is made the same by changing the magnification can be exhibited.

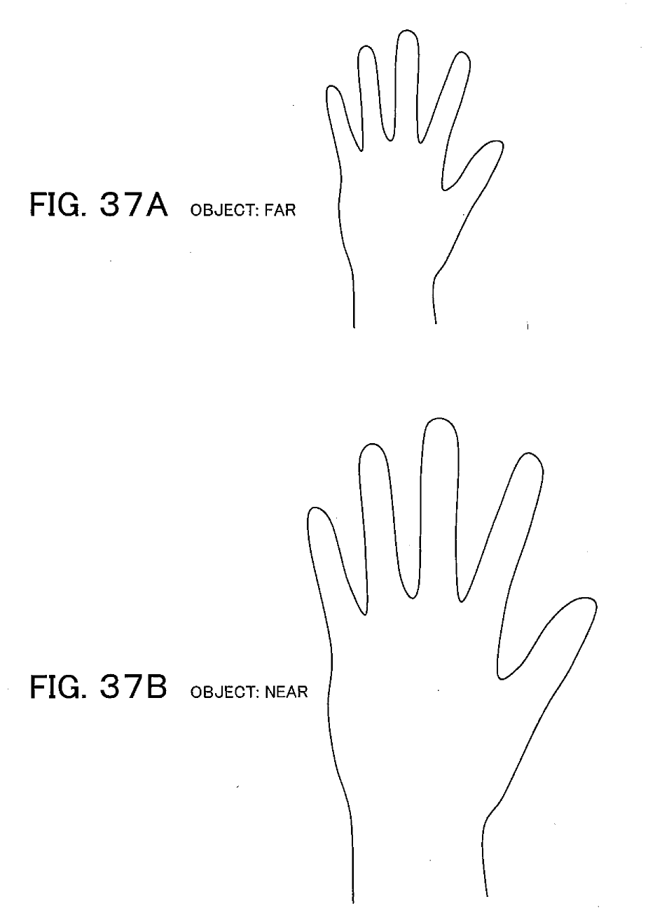

FIG. 37A and FIG. 37B are diagrams showing relationships of the size of the hand and pixels at the time of the capture in the case where the image capturing apparatus 140 (540) having the zoom optical system 210 is used.

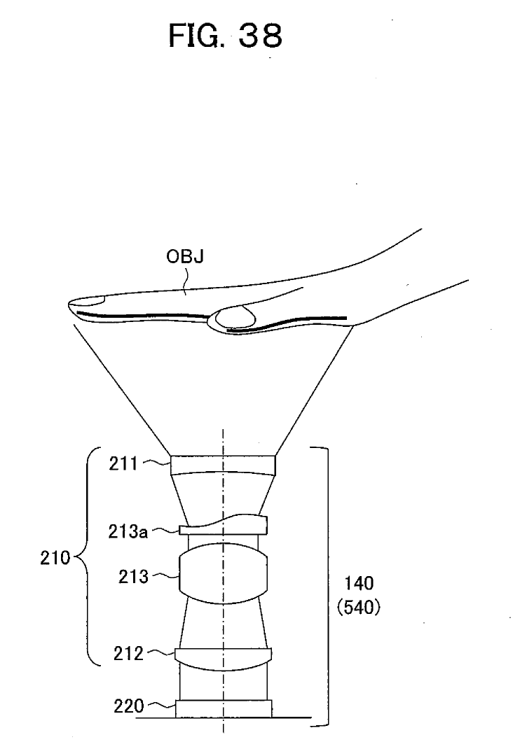

Further, FIG. 38 is a diagram showing a configuration obtained by inserting an optical wavefront modulation element 213a into the configuration shown in FIG. 35 and FIG. 36 and simultaneously shows that the capture of the palm veins is enabled as well.

Here, the lens is moved as shown in FIG. 35 and FIG. 36 in accordance with the size of the hand. Simultaneously, the inserted optical wavefront modulation element 213a is moved as well.

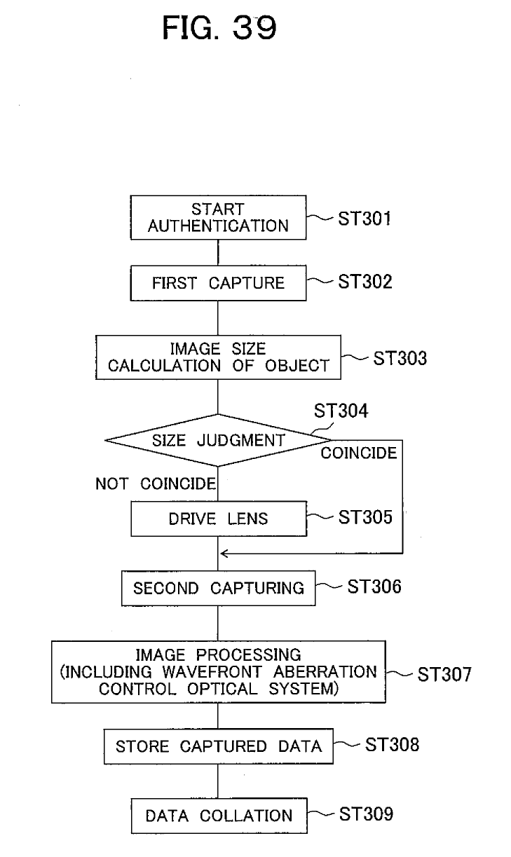

FIG. 39 is a diagram showing a schematic flow of operation of the capture and lens movement from the start of the authentication.

Here, the methods of the image processing and lens movement are not particularly described. However, the authentication is started (ST301), it is judged if the sizes of the object obtained by the first capture and obtained by calculation coincide (ST302 to ST304), when judged not to coincide, the difference is calculated, the lens is moved according to a drive amount corresponding to that difference, and the focal point distance is changed (ST305).

Thereafter, the second capture (true capturing for authentication) is carried out (ST306). As in the present embodiment, when the optical wavefront modulation element 213a is inserted, the corresponding image processing is carried out and an image having an extended field depth is obtained.

The image capturing apparatus 140 performs the image processing in the image processing apparatus 300 etc. including the wavefront aberration control optical system (ST307) and stores the captured data (ST308).

Then, it performs the collation based on the stored fingerprint data and vein data (ST309).

Note that the size of the hand and the held location (distance) can be dealt with by changing the magnification of the mounted lens. Further, so long as the lens is one for a long focal point distance, authentication becomes possible even at a location distant from the apparatus.

In the fifth embodiment, the authentication precision can be stabilized by making the resolution of the obtained image data constant. By simultaneously using the depth enlarging optical system, the problem that a sufficient resolution cannot be obtained in an object out of the depth in the usual optical system can be solved as well.

Next, an explanation will be given of a sixth embodiment concerning the adjustment function of the size of the object image fetched into the imaging element.

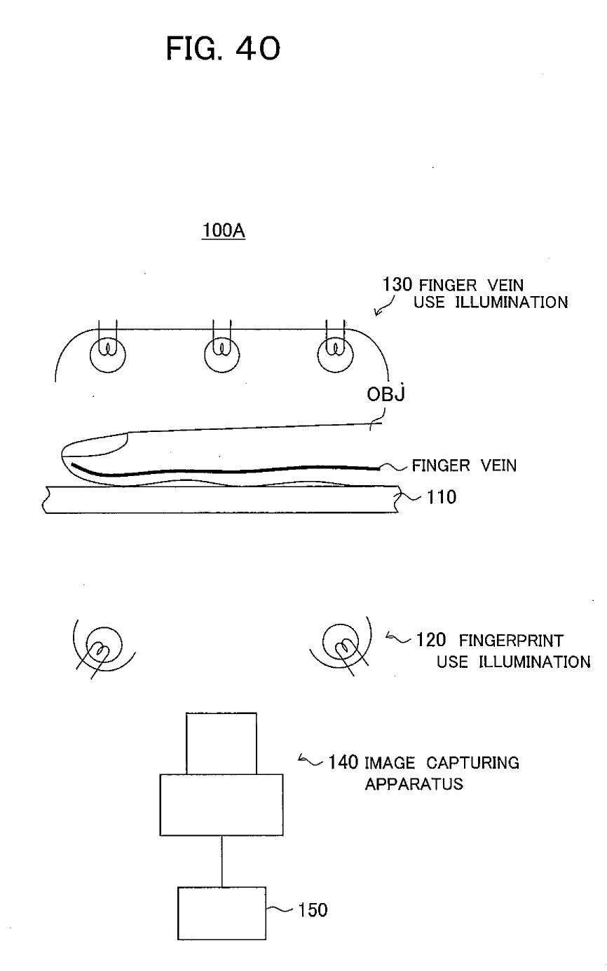

FIG. 40 is a diagram schematically showing an example of the configuration of a biometric authentication apparatus according to a sixth embodiment of the present invention.

The difference of a biometric authentication apparatus 100A of the sixth embodiment from the biometric authentication apparatus 100 of the first embodiment resides in that, at the time of the authentication, the image data generated at the image processing apparatus 300 of the object (inspected specimen) OBJ captured by the imaging element 220 is compared with the reference authentication data set in advance and the zoom optical system 210 is driven so as to adjust the size of the object image fetched by the imaging element 220.

Note that the reference authentication data is the data obtained by the imaging element 220 capturing the object in a state where the zoom optical system 210 is fixed at the predetermined location and generated at the image processing apparatus 300.

Corresponding to this, the biometric authentication apparatus 100A of FIG. 40 is, in addition to the configuration of the biometric authentication apparatus 100 of FIG. 1, provided with a storage unit 150 connected to the image capturing apparatus 140.

This storage unit 150 is a recording apparatus formed by a memory, hard disk, optical disk, or the like and registering the reference authentication data and storing the same.

In the sixth embodiment, basically, the storage unit 150 records and stores the data obtained by a CCD or other imaging element capturing the object in a state where the zoom optical system 210 including the optical wavefront modulation element is fixed at the predetermined location and generated at the image processing apparatus 300, that is, the reference authentication data.

The rest of the configuration of the biometric authentication apparatus 100A of FIG. 6 is the same as that of the biometric authentication apparatus 100 of FIG. 1.

In the sixth embodiment, as explained in the fifth embodiment, by employing the zoom optical system 210, even a change of the size of the object (inspected specimen) can be coped with, the resolution of the captured image due to the location of the object is maintained, and the authentication precision is improved.

Namely, the image capturing apparatus 140 of the present embodiment can adjust the size of the object input to the imaging element 220 to a constant size by the zoom optical system 210.

Further, the zoom optical system 210 is controlled so as to become the operating state when the authenticated object, for example, fingerprint or vein, changes.

In the sixth embodiment as well, in the same way as the fifth embodiment, as shown in FIG. 34, by providing the zoom optical system 210, it becomes possible to adjust for example the size of the hand input to the imaging element 220 to a certain specific size.

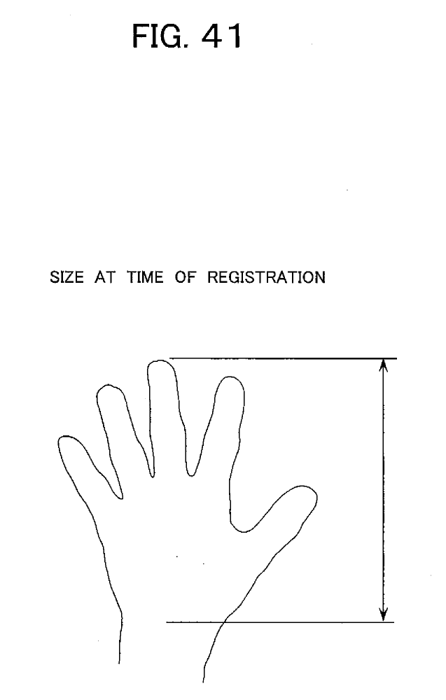

Below, an explanation will be given of the adjustment and authentication capability according to the sixth embodiment with reference to FIG. 41 to FIG. 48.

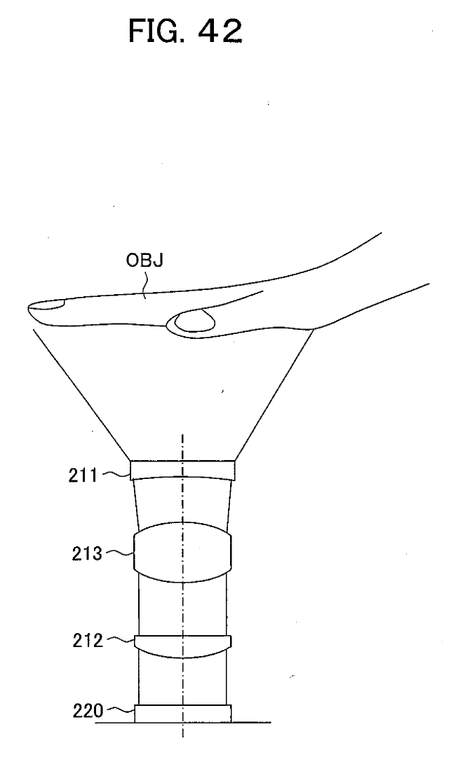

FIG. 41 and FIG. 42 are schematic diagrams showing the size of the image at a point of time when the reference authentication data is registered. FIG. 41 shows the size of the object image at the time of the registration, and FIG. 42 shows a state at the time of the registration by the image capturing apparatus of the present embodiment.

Simultaneously with the registration of this reference authentication data, the resolution is determined at this point of time. Here, the location where the registered person holds aloft his hand can be confirmed by displaying the state of capture by separately providing a display portion when performing the registration.

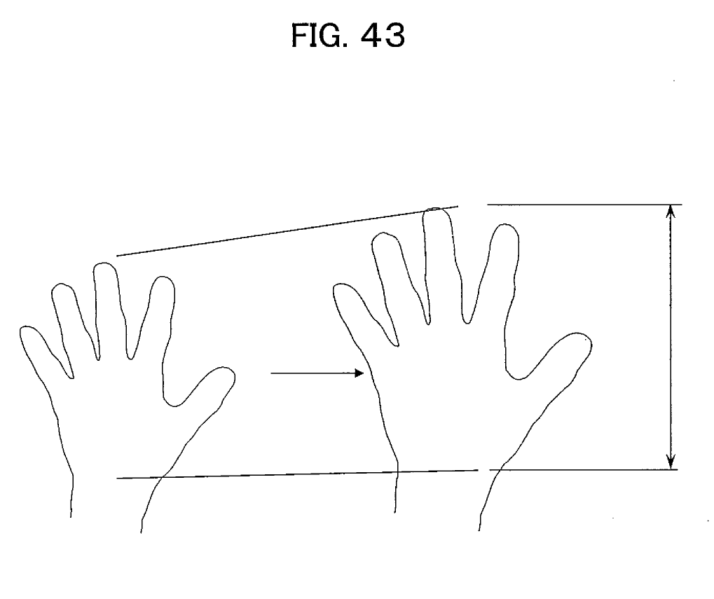

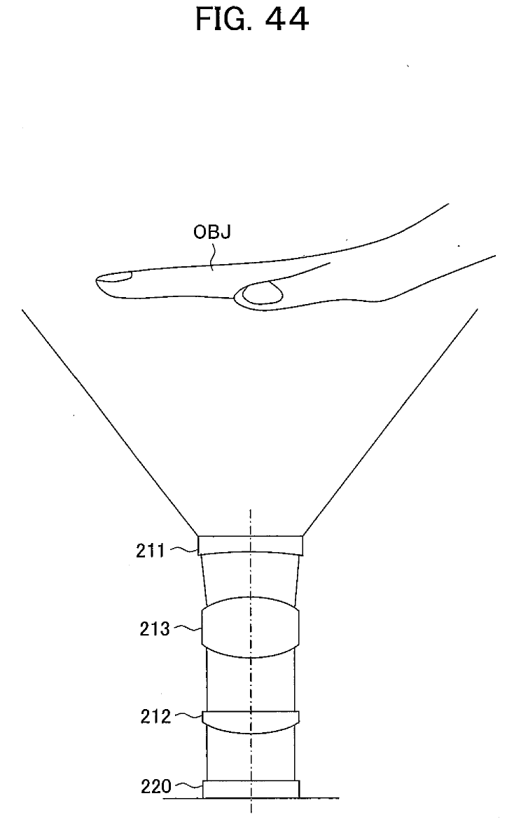

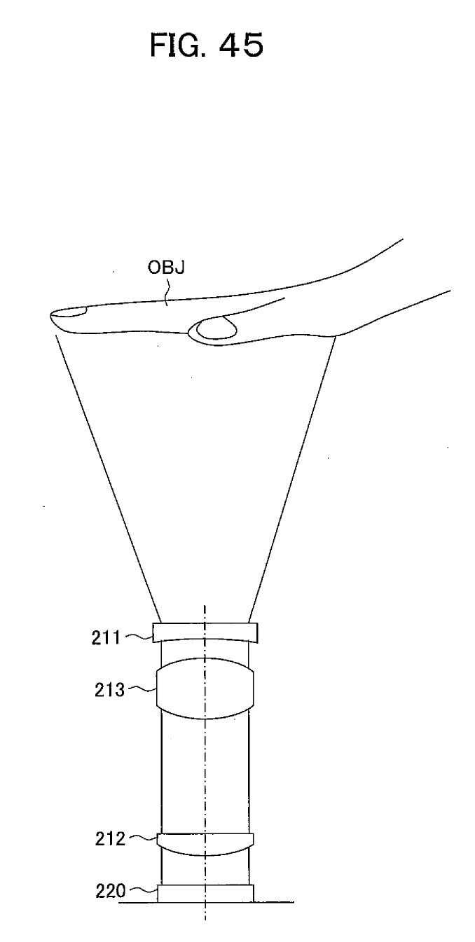

FIG. 43, FIG. 44, and FIG. 45 are diagrams showing that the imaging size of the inspected specimen changes (becomes small here) according to the location for holding aloft the hand and showing a state where the captured image size is made the same as the size at the time of the registration by changing the magnification by moving the optical system.

FIG. 43 is a diagram showing a size at the time of a provisional capture (no change of magnification) and a size at the time of the true capture (time of authentication), FIG. 44 is a diagram showing a state where the inspected specimen is further away than that at the time of the registration, and FIG. 45 is a diagram showing a state (after the change of the magnification) at the time of the authentication (time of capture).

In a case where the location where the hand is held aloft becomes farther away as in FIG. 44, when the capture is carried out by an optical system having a single focal point, the hand is captured small as in the left diagram of FIG. 43. Namely, this is a low resolution state.

However, by using the zoom optical system 210 as shown in FIG. 45 and changing the focal point distance in accordance with the location of the inspected specimen, capture with the same resolution as that at the time of the registration becomes possible.

As a result, comparisons and collations with the same size and same resolution are achieved, therefore the reliability thereof is improved. Simultaneously, restrictions on the location for holding the hand aloft are eased, so the restrictions on the user are eased.

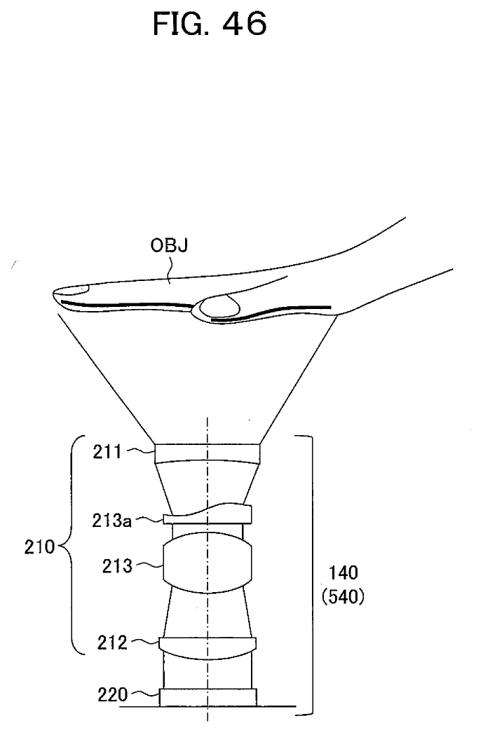

FIG. 46 is a diagram showing a configuration obtained by inserting an optical wavefront modulation element 213a into the configuration shown in FIG. 42, FIG. 44, and FIG. 45 and shows that the capture of the palm veins is simultaneously enabled as well. Here, it is assumed that the lens is moved as shown in FIG. 42 in accordance with the size of the hand. Simultaneously, the inserted optical wavefront modulation element 213a is moved as well.

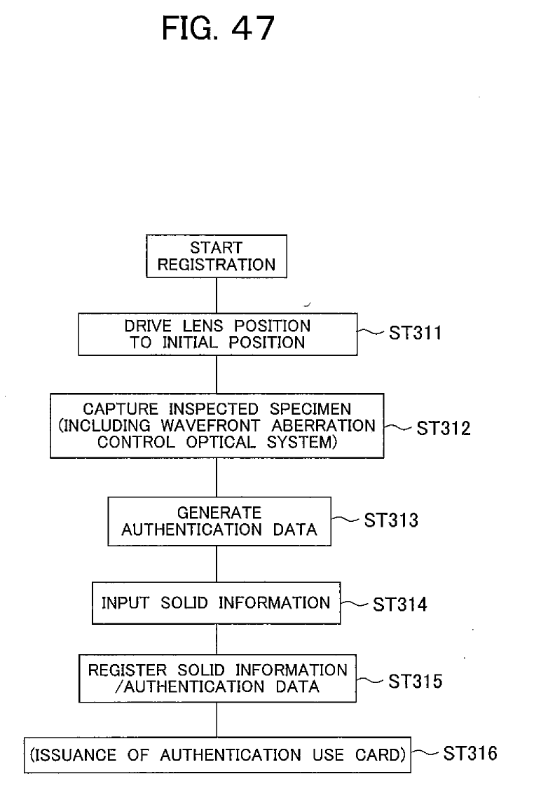

FIG. 47 is a flow chart showing a schematic flow when registering the reference authentication data.

Here, the content of the solid information might change according to need, but this is not particularly described here. Further, preparation of an authentication use card as the key required at the time of the authentication is shown as an example. Other than this, a code number can be used as the key as well.

In the example of FIG. 47, first, the lens is driven to an initial position (ST311), and the inspected specimen is captured (ST312).

Then, the authentication data is prepared (ST313), and the solid information is input (ST314).

Then, the solid information and reference authentication data are registered (ST315), and for example an authentication use IC card is issued (ST316).

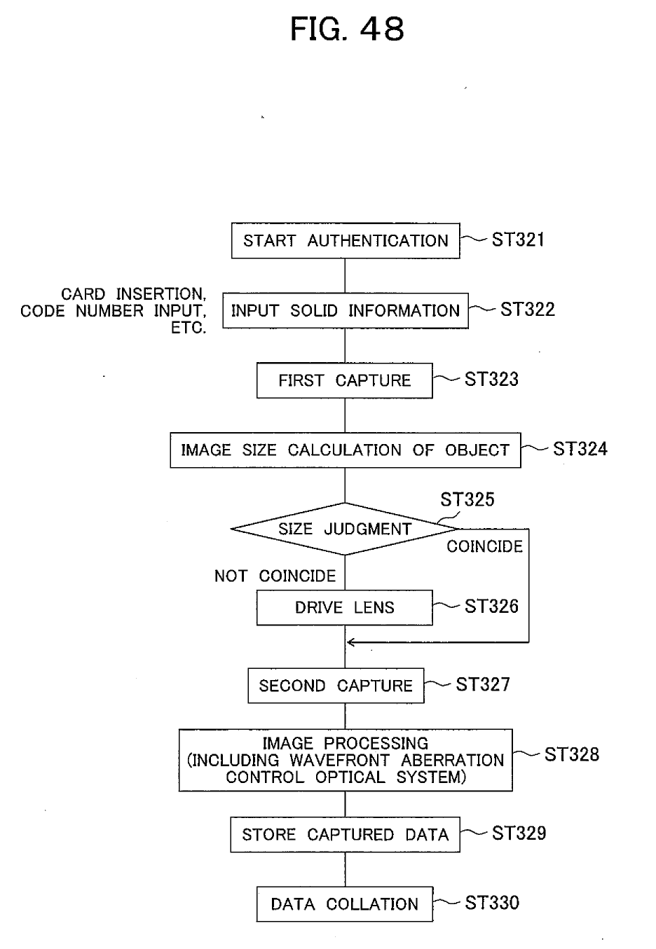

FIG. 48 is a diagram showing a schematic flow of operation of the capture and lens movement after the start of the authentication.

Here, the methods of image processing and lens movement are not particularly described. However, the authentication is started (ST321), the solid information is input (ST322), and it is judged if the object size of the image obtained by the first capture at (provisional capture) and obtained by the calculation coincide (ST323 to ST325). When judged not to coincide, the difference is calculated, the lens is moved according to the drive amount corresponding to that difference, and the focal point distance is changed (ST326).

After this, the second capture (true capture for authentication) is carried out (ST327). When the optical wavefront modulation element 213a is inserted as in the present embodiment, the corresponding image processing is carried out and an image having an extended field depth is obtained.

The image capturing apparatus 140 performs the image processing in the image processing apparatus 300 etc. including the wavefront aberration control optical system (ST328) and stores the captured data (ST329).

Then, the collation based on the stored fingerprint data and vein data is carried out (ST330).

Note that, the size of the hand and the location for holding aloft the hand (distance) can be handled by changing the magnification of the mounted lens. Further, so far as the lens is for a long focal point distance, authentication becomes possible even at a location far away from the apparatus.

In the present embodiment, the authentication precision can be stabilized by making the resolution of the obtained image data constant. Simultaneously, by using the depth enlarging optical system, the problem that a sufficient resolution no longer can be obtained in an object out of the depth in the usual optical system can be solved.

Next, an explanation will be given of a seventh embodiment concerning the adjustment function of the size of the object image fetched into the imaging element.

The fundamental configuration of a biometric authentication apparatus 100B according to the seventh embodiment is the same as that of the biometric authentication apparatus 100A shown in FIG. 40. Accordingly, an explanation is given here with reference to FIG. 40.

In the seventh embodiment, basically, the storage unit 150 records and stores the data obtained by the CCD or other imaging element capturing the object in a state where the zoom optical system 210 including the optical wavefront modulation element is fixed at a predetermined location and generated by the image processing apparatus for a plurality of portions, that is, the reference authentication data.

Then, in the biometric authentication apparatus 100B of the seventh embodiment as well, at the time of the authentication, the image data generated by the image processing apparatus of the object captured by the imaging element and the reference authentication data set in advance are compared to perform the authentication.

Namely, in the seventh embodiment, by using a plurality of data used for authentication with respect to one person and changing a quantity of portions for the authentication or changing the combination of the plurality of data in accordance with the authentication level (security level) of the plurality of data, authentication with a high security is realized.

For example, the authentication is carried out by changing the number or combination of portions for the authentication in accordance with a protection level.

Further, a plurality of authentication portions are automatically generated at the time of registration of the reference authentication data.

Further, automatic or manual selection of the generated authentication portion is enabled.

In the seventh embodiment as well, by employing the zoom optical system 210, even a change of the size of the object (inspected specimen) can be coped with, the resolution of the captured image due to the location of the object is kept, and the authentication precision is improved.

Namely, the image capturing apparatus 140 of the present embodiment can adjust the size of the object input to the imaging element 220 to a constant size by the zoom optical system 210.

Further, the zoom optical system 210 is controlled so as to become the operating state when the fingerprint, vein, or other authenticated object changes.

In the seventh embodiment as well, in the same way as the fifth and sixth embodiments, as shown in FIG. 34, by providing the zoom optical system 210, for example the adjustment of the size of the hand input to the imaging element 220 to a certain specific size becomes possible.

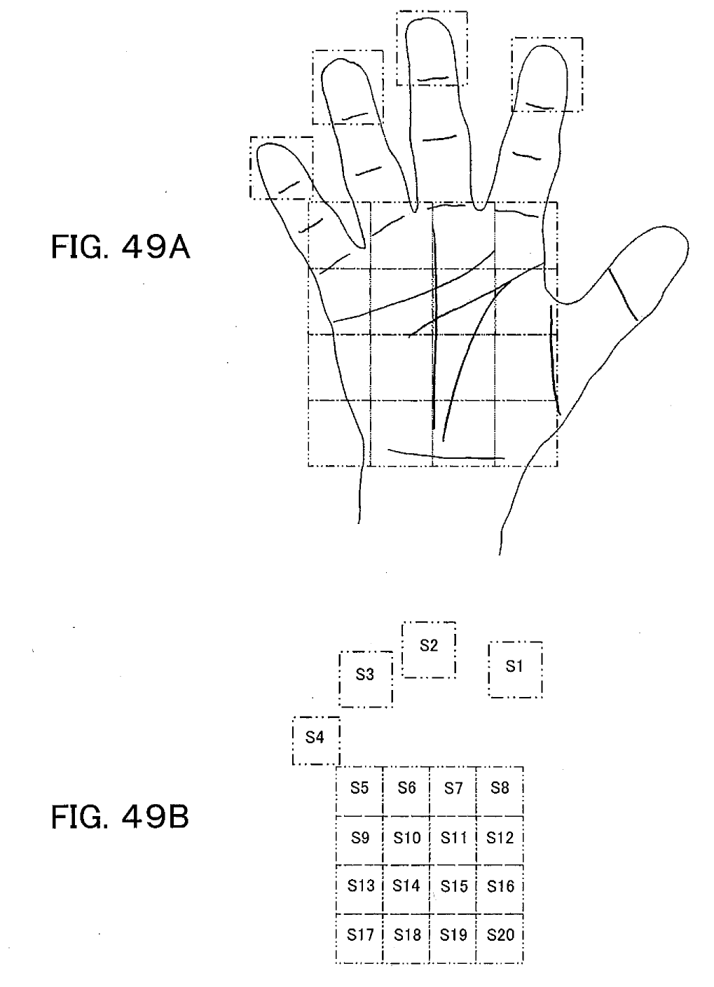

Below, an explanation will be given of the adjustment and authentication functions according to the seventh embodiment with reference to FIGS. 49A and 49B to FIG. 56.

FIG. 49A and FIG. 49B are examples showing portions of the hand to be authenticated. Here, these are schematic views showing the forefinger pad (region S1), middle finger pad (region S2), third finger pad (region S3), pinky pad (region S4), and palm divided into 16 regions S5 to S20.

Here, the number of divisions is one example and not limited.

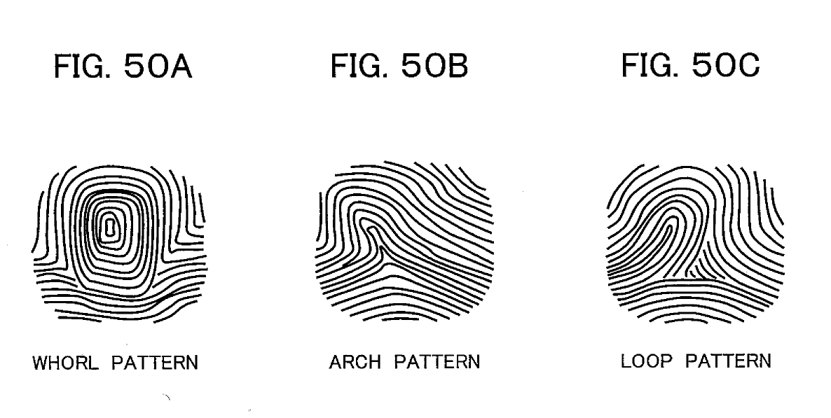

FIG. 50A to FIG. 50C are diagrams showing representative patterns of the fingerprint, in which FIG. 50A shows a whorl pattern, FIG. 50B shows an arch pattern, and FIG. 50C shows a loop pattern.

The fingerprint patterns of all fingers of one person are not constant. Naturally, these are representative patterns. It goes without saying that the probability of existence of the same fingerprint pattern is very small.

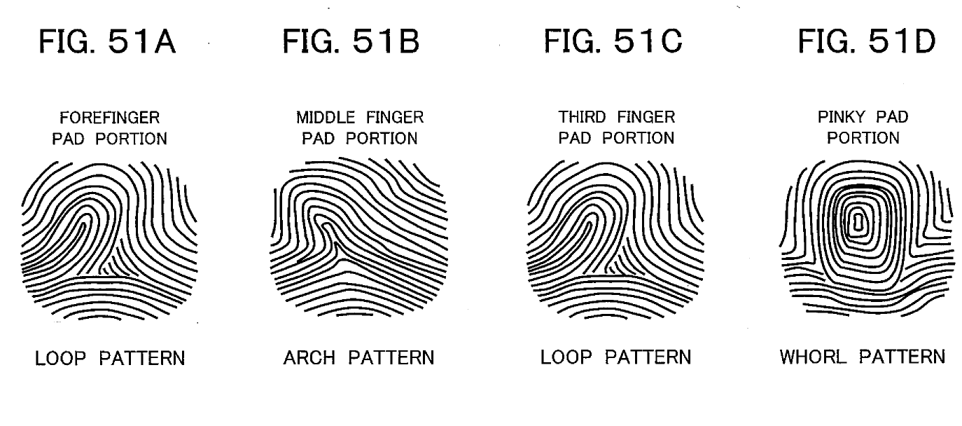

FIG. 51A to FIG. 51D are diagrams showing examples of fingerprint patterns of one person, in which FIG. 51A shows that a loop pattern exists in the forefinger pad portion, FIG. 51B shows that an arch pattern exists in the middle finger pad portion, FIG. 51C shows that a loop pattern exists in the third finger pad portion, and FIG. 51D shows that a whorl pattern exists in the pinky pad portion.

With respect to the probability of coincidence of one fingerprint with the fingerprint of another person, the probability of coincidence when forming combinations becomes lower due to the multiplication rate of the combinations.

Namely, when considering this by using the examples of FIG. 51A to FIG. 51D, the probability of coincidence with respect to one fingerprint is 1/4 power. On the other hand, even in a case where the coincidence rate with respect to one fingerprint is lowered, this can be supplemented by using a combination.

As an example of raising or lowering the coincidence rate, there is the resolution at the time of imaging.

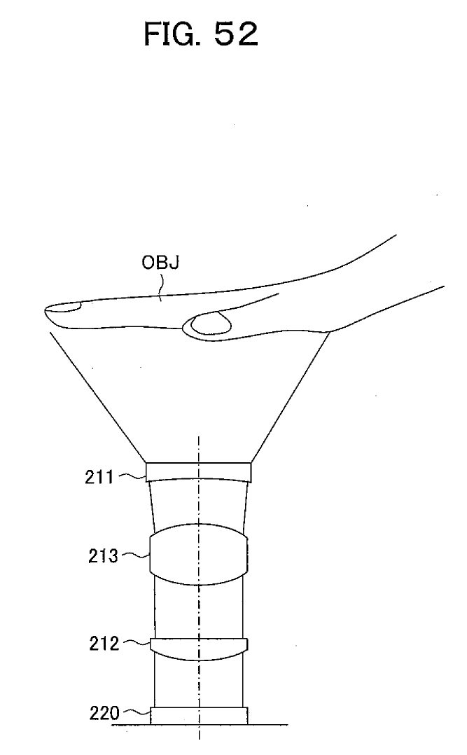

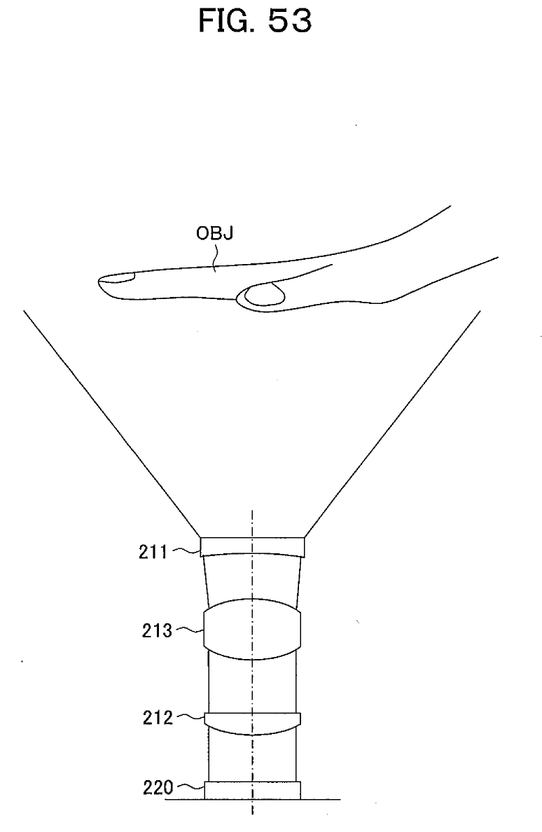

FIG. 52 shows that an image can be captured in a high resolution state, and FIG. 53 shows an example where the resolution is lowered since the location where the hand is held aloft becomes distant.

Further, other than this, dirt, scratches, etc. of the authenticated portion can be considered as well. The above content is true for the palm print as well.

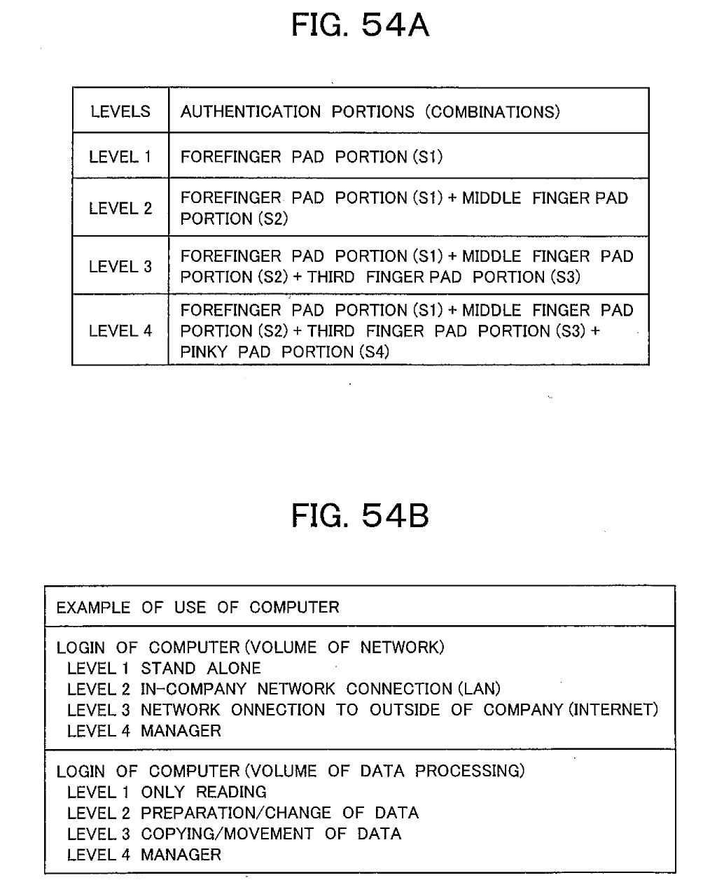

FIG. 54A shows where the authentication level is set according to the combination of fingerprints.

In the example of FIG. 54A, level 1 is the authentication portion=forefinger pad portion (S1), level 2 is the authentication portions=forefinger pad portion (S1)+middle finger pad portion (S2), level 3 is the authentication portions=forefinger pad portion (S1)+middle finger pad portion (S2)+third finger pad portion (S3), and level 4 is the authentication portions=forefinger pad portion (S1)+middle finger pad portion (S2)+third finger pad portion (S3)+pinky pad portion (S4). The higher the level, the larger the number of combinations of the authentication portions, whereby the security level is set.

Specifically, as shown in FIG. 54B, the authentication level, that is, the security level is stepwise set taking as an example combinations of fingerprints of four fingers. As an example of use, an explanation will be given by taking as an example a login of a computer.

In the case of the connection to the network, level 1 is set in the use standing alone, level 2 is set in an intra-company network connection (LAN), level 3 is set in an access connection to the outside of the company (Internet), and level 4 is set in a manager (lifting of restriction). Other than this, in the case of the login to the computer, level 1 indicates only reading, level 2 indicates preparation and change of data, level 3 indicates copying and movement of the data, and level 4 indicates the manager (lifting of restriction).

This is true also for actions other than the login of a computer, for example permission of entering into a building, department, or room. It can be considered that these levels be applied to all formats of stepwise permission.

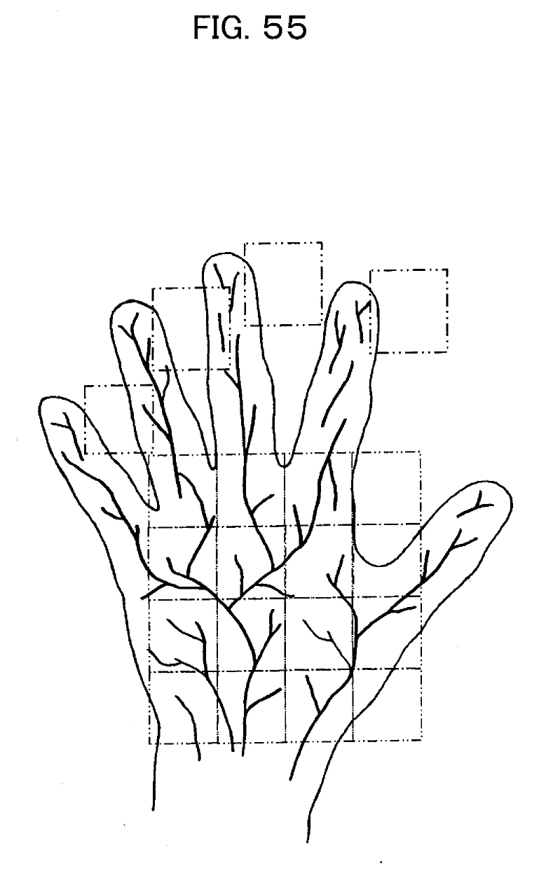

FIG. 55 replaces the authentication of the fingerprint by vein authentication. The veins can be authenticated in the same way as the fingerprint.

The authentication precision is greatly improved in comparison with the conventional fingerprint authentication and vein authentication. Further, by combining both authentications, further improvement of authentication rate of a true person becomes possible, and a high grade authentication apparatus becomes possible.

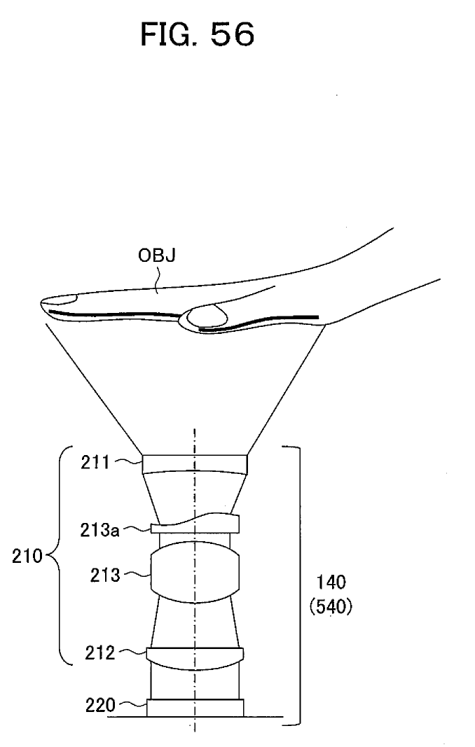

FIG. 56 changes the optical system explained above to the depth enlarging optical system having an optical wavefront modulation element 213a. Further, this simultaneously shows that the capture of the palm veins is enabled as well.

Note that the size of the hand and the location where the hand is held aloft (distance) can be handled by changing the magnification of the mounted lens. Further, so far as the lens is for a long focal point distance, authentication becomes possible even at a location far away from the apparatus.

In the seventh embodiment, the authentication precision can be stabilized by making the resolution of the obtained image data constant. Simultaneously, by using the depth enlarging optical system, the problem that the sufficient resolution no longer can be obtained in an object out of the depth in the conventional optical system can be solved.

### INDUSTRIAL APPLICABILITY

A biometric authentication apparatus of the present invention can easily focus on a fingerprint and blood vessel pattern such as veins with a simple configuration, can clearly capture the image, can prevent forgery, and can realize fingerprint authentication, vein authentication and further iris authentication and other authentications with a high precision, therefore can be applied to various types of apparatuses regarding security.

1-31. (canceled)

32. A biometric authentication apparatus having an image capturing apparatus for capturing an authenticated object, wherein
the image capturing apparatus includes
an optical system and an optical wavefront modulation element,
an imaging element for capturing a dispersed image of an object passing through the optical system and the optical wavefront modulation element, and
a converting means for generating a dispersion-free image signal from a dispersed image signal from the imaging element.

33. A biometric authentication apparatus as set forth in claim 32, wherein
the apparatus has an information introduction unit able to introduce a plurality of authentication use information light of a different plurality of portions guided through predetermined light paths into the imaging element, and
the biometric authentication apparatus performs authentication operations on the different plurality of portions.

34. A biometric authentication apparatus as set forth in claim 33, wherein
the optical wavefront modulation element is formed in the information introduction unit.

35. A biometric authentication apparatus as set forth in claim 32, wherein
the optical system includes a zoom optical system, and
the image capturing apparatus able to adjust a size of an object input to the imaging element to a constant size by the zoom optical system.

36. A biometric authentication apparatus as set forth in claim 35, wherein
the zoom optical system is set in the operating state when the authenticated object changes.

37. A biometric authentication apparatus as set forth in claim 32, wherein
the optical system includes a zoom optical system,
the biometric authentication apparatus further has an image processing means for applying predetermined image processing to the image captured by the imaging element and,
at the time of the authentication, compares the image data of the object captured by the imaging element generated by the image processing means with a reference authentication data set in advance and drives the zoom optical system so as to adjust the size of an object image fetched by the imaging element, and
the reference authentication data is data obtained by the imaging element capturing the object in a state where the zoom optical system is fixed at a predetermined location and generated by the image processing means.

38. A biometric authentication apparatus as set forth in claim 37, wherein
the image capturing apparatus is controlled so as to read two different predetermined patterns to perform the biometric authentication.

39. A biometric authentication apparatus as set forth in claim 37, wherein
the zoom optical system is set in the operating state when the authenticated object changes.

40. A biometric authentication apparatus as set forth in claim 32, wherein
the biometric authentication apparatus further has an image processing means for applying predetermined image processing to the image captured by the imaging element and,
at the time of the authentication, selects a number or combination of authentication portions and compares the image data of the selected authentication portions of the object captured by the imaging element with the reference authentication data to perform the authentication, and
the reference authentication data is the data obtained by the imaging element capturing the object and generated for a plurality of positions by the image processing means.

41. A biometric authentication apparatus as set forth in claim 40, wherein
the image capturing apparatus is controlled so as to read two different predetermined patterns to perform the biometric authentication.

42. A biometric authentication apparatus as set forth in claim 40, wherein:
the optical system includes a zoom optical system, and
the zoom optical system is set in the operating state when the authenticated object changes.

43. A biometric authentication apparatus as set forth in claim 32, wherein
the authenticated object includes a fingerprint and blood vessel.

44. A biometric authentication apparatus as set forth in claim 33, wherein
the different plurality of portions include a fingerprint and blood vessel or a blood vessel and iris.

45. A biometric authentication apparatus as set forth in claim 32, wherein
a priority order of authentication results able to be switched in accordance with the situation.

46. A biometric authentication apparatus as set forth in claim 32, wherein
the image capturing apparatus comprises an object distance information generating means for generating information corresponding to a distance up to an object, and
the converting means generates a dispersion-free image signal from the dispersed image signal based on the information generated by the object distance information generating means.

47. A biometric authentication apparatus as set forth in claim 46, wherein
the image capturing apparatus comprises
a conversion coefficient storing means for storing in advance two or more conversion coefficients corresponding to the dispersion caused by at least the optical wavefront modulation element in accordance with the object distance and
a coefficient selecting means for selecting a conversion coefficient in accordance with the distance up to the object from the conversion coefficient storing means based on the information generated by the object distance information generating means, and
the converting means converts the image signal according to the conversion coefficient selected at the coefficient selecting means.

48. A biometric authentication apparatus as set forth in claim 46, wherein
the image capturing apparatus comprises
a conversion coefficient operation means for computing a conversion coefficient based on the information generated by the object distance information generating means, and
the converting means converts the image signal according to the conversion coefficient obtained from the conversion coefficient operation means.

49. A biometric authentication apparatus as set forth in claim 32, wherein
the optical system including a zoom optical system, and
the image capturing apparatus comprises
a correction value storing means for storing in advance at least one correction value in accordance with a zoom position or zoom amount of the zoom optical system,
a second conversion coefficient storing means for storing in advance conversion coefficients corresponding to the dispersion caused by at least the optical wavefront modulation element, and
a correction value selecting means for selecting a correction value in accordance with the distance up to the object from the correction value storing means based on the information generated by the object distance information generating means, and
the converting means converts the image signal according to the conversion coefficient obtained from the second conversion coefficient storing means and the correction value selected by the correction value selecting means.

50. A biometric authentication apparatus as set forth in claim 49, wherein
the correction value stored in the correction value storing means includes a kernel size of the dispersed image of the object.

51. A biometric authentication apparatus as set forth in claim 32, wherein
the image capturing apparatus comprises
an object distance information generating means for generating information corresponding to a distance up to an object and
a conversion coefficient operation means for computing a conversion coefficient based on the information generated by the object distance information generating means, and
the converting means converts the image signal according to the conversion coefficient obtained from the conversion coefficient operation means and generates a dispersion-free image signal.

52. A biometric authentication apparatus as set forth in claim 51, wherein
the conversion coefficient operation means includes a kernel size of the dispersed image of the object as a variable.

53. A biometric authentication apparatus as set forth in claim 51, wherein
the apparatus has a storing means,
the conversion coefficient operation means stores a found conversion coefficient in the storing means, and
the converting means converts the image signal according to the conversion coefficient stored in the storing means and generates a dispersion-free image signal.

54. A biometric authentication apparatus as set forth in claim 51, wherein
the converting means performs a convolution operation based on the conversion coefficient.

55. A biometric authentication apparatus comprising an image capturing apparatus for reading predetermined patterns of predetermined portions, wherein
the image capturing apparatus has
a zoom optical system,
an imaging element for capturing an image passing through the zoom optical system, and
an image processing means for applying predetermined image processing to an image captured by the imaging element and,
at the time of the authentication, compares the image data of the object captured by the imaging element generated by the image processing means with reference authentication data set in advance and drives the zoom optical system so as to adjust the size of an object image fetched by the imaging element,
the reference authentication data is data obtained by the imaging element capturing the object in a state where the zoom optical system is fixed at the predetermined location and generated by the image processing means,
the zoom optical system includes an optical wavefront modulation element,
the imaging element captures a dispersed image of an object passing through the zoom optical system and the optical wavefront modulation element, and
the image processing means generates a dispersion-free image signal from the dispersed image signal from the imaging element.

56. A biometric authentication apparatus as set forth in claim 55, wherein
the image capturing apparatus is controlled so as to read two different predetermined patterns to perform the biometric authentication.

57. A biometric authentication apparatus as set forth in claim 55, wherein
the zoom optical system is set in the operating state when the authenticated object changes.

58. A biometric authentication apparatus comprising with an image capturing apparatus for reading predetermined patterns of predetermined positions, wherein
the image capturing apparatus has
an optical system,
an imaging element for capturing an image passing through the optical system, and
an image processing means for applying predetermined image processing to an image captured by the imaging element and,
at the time of the authentication, selects a number or combination of authentication portions and compares the image data of the selected authentication portions of the object captured by the imaging element with the reference authentication data to perform the authentication,
the reference authentication data is data generated for a plurality of portions by the image processing means by the imaging element capturing the object,
the optical system includes an optical wavefront modulation element,
the imaging element captures a dispersed image of an object passing through the optical system and the optical wavefront modulation element, and
the image processing means generates a dispersion-free image signal from the dispersed image signal from the imaging element.

59. A biometric authentication apparatus as set forth in claim 57, wherein
the image capturing apparatus is controlled so as to read two different predetermined patterns to perform the biometric authentication.

60. A biometric authentication apparatus as set forth in claim 57, wherein:
the optical system includes a zoom optical system, and
the zoom optical system is set in the operating state when the authenticated object changes.
